(19) United States
(12) Patent Application Publication
(10) Pub. No.: US 2017/0054339 A1
(43) Pub. Date: Feb. 23, 2017

(54) STATOR OF ROTARY ELECTRICAL MACHINE AND ROTARY ELECTRICAL MACHINE USING SUCH STATOR

(71) Applicant: Mitsubishi Electric Corporation, Chiyoda-ku, Tokyo (JP)

(72) Inventors: Masaya HARAKAWA, Chiyoda-ku, Tokyo (JP); Kenta OZAKI, Chiyoda-ku, Tokyo (JP); Shinichi YAMAGUCHI, Chiyoda-ku, Tokyo (JP); Kentaro HORISAKA, Chiyoda-ku, Tokyo (JP); Kazuaki ANDO, Chiyoda-ku, Tokyo (JP); Koki NAKA, Chiyoda-ku, Tokyo (JP)

(73) Assignee: Mitsubishi Electric Corporation, Chiyoda-ku, Tokyo (JP)

(21) Appl. No.: 15/305,882

(22) PCT Filed: Apr. 24, 2014
(86) PCT No.: PCT/JP2014/002301

§ 371 Date: Oct. 21, 2016

(51) Int. Cl. H02K 3/28; H02K 1/27; H02K 3/12; H02K 1/14

(52) U.S. Cl. CPC H02K 3/28; H02K 1/146; H02K 1/2706; H02K 3/12

(57) ABSTRACT

A stator of a rotary electrical machine according to the invention includes a core back, a plurality of teeth, a plurality of slots, and a coil. The coil is configured by a plurality of conductor wires. Between inside of the slot and outside of the slot, the plurality of conductor wires are bent at an angle smaller than 180° in a circumferential direction of the core back, and between the bent part and the inside of the slot, the plurality of conductor wires are bent in the circumferential direction of the core back and in an opposite direction to a bending direction of the bent part.

### TECHNICAL FIELD

The present invention relates to a stator for use in a rotary electrical machine such as an electric motor or a power generator, and a rotary electrical machine using such stator.

### BACKGROUND ART

In a background-art rotary electrical machine, a stator is constituted by a stator core and stator windings. The stator core has an annular shape including a plurality of slots on the inner circumferential side. The stator windings are wound in the slots of the stator core.

FIG. 44 is a view of a background-art rotary electrical machine, in which coil end portions 2017c are observed from the inside of a stator core 2005. In the background-art rotary electrical machine, stator windings includes a plurality of coils 2017 as shown in FIG. 44. In FIG. 44, a coil 2017X, a coil 2017Y and a coil 2017Z are the coils 2017 respectively. Each coil 2017 has a lower coil portion 2017a and an upper coil portion 2017b. The lower coil portion 2017a and the upper coil portion 2017b are inserted into a slot of the stator core 2005. In addition, the coil 2017 has a coil end portion 2017c and a coil end portion 2017d. The coil end portion 2017c is a part connecting one end portion of the upper coil portion 2017b with one end portion of the lower coil portion 2017a. The coil end portion 2017d is a part connecting the other end portion of the upper coil portion 2017b with the other end portion of the lower coil portion 2017a. The coil end portion 2017c and the coil end portion 2017d are parts that will be exposed to the axially outer side of the stator core 2005 when the coil 2017 is inserted into the slot of the stator core 2005.

The lower coil portion 2017a of the coil 2017 is a part inserted and disposed on a deeper side of the slot of the stator core 2005. On the other hand, the upper coil portion 2017b is a part disposed on an entrance side of the slot of the stator core 2005. Thus, the coil end portion 2017c can be observed from the inside of the assembled stator as shown in FIG. 44.

In addition, in FIG. 44, a part 2017ca designates a part of the coil end portion 2017c close to the lower coil portion 2017a. A part 2017cb designates a part of the coil end portion 2017c close to the upper coil portion 2017b (for example, see Patent Literature 1).

### CITATION LIST

### Patent Literature

### Patent Literature 1: JP-A-H09-261904 (Paragraphs 0004, 0029 to 0031, 0033, and 0043, and FIG. 1 to FIG. 3)

### SUMMARY OF THE INVENTION

### Problem that the Invention is to Solve

In the technique of Patent Literature 1, as shown in FIG. 44, in the position of a part A, the part 2017ca of the coil end portion 2017c of the coil 2017X is located on the axially outer side of the part 2017cb of the coil end portion 2017c of the coil 2017Y. In the position of a part B, the part 2017ca of the coil end portion 2017c of the coil 2017X is located on the axially outer side of the part 2017cb of the coil end portion 2017c of the coil 2017Z.

That is, in the technique of Patent Literature 1, when it is intended to reduce the axial height of the coil end portions 2017c, the part 2017ca of the coil end portion 2017c of the coil 2017X interferes with the part 2017cb of the coil end portion 2017c of the coil 2017Y in the position of the part A. Incidentally, the interference means that a winding position of one coil overlaps with a winding position of another coil. In the same manner, the part 2017ca of the coil end portion 2017c of the coil 2017X interferes with the part 2017cb of the coil end portion 2017c of the coil 2017Z in the position of the part B.

An object of the present invention is to solve the foregoing problem belonging to the background art and to provide a stator of a rotary electrical machine in which a height of a coil end portion is reduced without generating interference among coils as compared with that in the background art, and a rotary electrical machine using such stator.

### Means for Solving the Problem

A stator of a rotary electrical machine according to the present invention includes a core back that is formed in an annular shape, a plurality of teeth that are provided in a circumferential direction of the core back, a plurality of slots that are provided between the teeth; and a coil including a plurality of conductor wires which are arranged in m stages (m is an integer of 2 or larger) in a radial direction of the core back inside the slots and arranged in n stages (n is an integer of 1 or larger and not larger than ½ of m) in the radial direction of the core back outside the slots, wherein between the inside of the slot and the outside of the slot, the plurality of conductor wires configuring the coil are bent at an angle smaller than 180° in the circumferential direction of the core back, and between the bent part and the inside of the slot, the plurality of conductor wires configuring the coil are bent in the circumferential direction of the core back and in an opposite direction to a bending direction of the bent part.

### Advantage of the Invention

According to the invention, it is possible to provide a stator of a rotary electrical machine in which the height of a coil end portion can be reduced without generating interference among coils as compared with that in the background art, and a rotary electrical machine using such stator.

### BRIEF DESCRIPTION OF THE DRAWINGS

FIG. 1 A configuration diagram of a stator of a rotary electrical machine according to Embodiment 1.

FIG. 2 A configuration diagram of a coil forming stator windings according to Embodiment 1.

FIG. 3 A view showing a sectional view of the rotary electrical machine according to Embodiment 1.

FIG. 4 A view showing a state in which the coil has been inserted into a stator core according to Embodiment 1, the state being observed from the top of the stator core.

FIG. 5 A view showing the state in which the coil has been inserted into the stator core according to Embodiment 1, the state being observed from the bottom of the stator core.

FIG. 6 A view showing the state in which the coil has been inserted into the stator core according to Embodiment 1, the state being observed from a side of the stator core.

FIG. 7 A view for explaining bending angles of a conductor wire forming the coil according to Embodiment 1.

FIG. 8 A configuration view of windings for each phase in the stator in which coils have been inserted into the stator core according to Embodiment 1.

FIG. 9 A view showing a state in which a coil has been inserted into a stator core according to Embodiment 2, the state being observed from the top of the stator core.

FIG. 10 A view showing the state in which the coil has been inserted into the stator core according to Embodiment 2, the state being observed from the bottom of the stator core.

FIG. 11 A view showing the state in which the coil has been inserted into the stator core according to Embodiment 2, the state being observed from a side of the stator core.

FIG. 12 A view for explaining bending angles of a conductor wire forming the coil according to Embodiment 2.

FIG. 13 A configuration view of windings for each phase in the stator in which coils have been inserted into the stator core according to Embodiment 2.

FIG. 14 A view showing a state in which a coil has been inserted into a stator core according to Embodiment 3, the state being observed from the top of the stator core.

FIG. 15 A view showing the state in which the coil has been inserted into the stator core according to Embodiment 3, the state being observed from the bottom of the stator core.

FIG. 16 A view showing the state in which the coil has been inserted into the stator core according to Embodiment 3, the state being observed from a side of the stator core.

FIG. 17 A view for explaining bending angles of a conductor wire forming the coil according to Embodiment 3.

FIG. 18 A configuration view of windings for each phase in the stator in which coils have been inserted into the stator core in order to form stator windings of a rotary electrical machine according to Embodiment 3.

FIG. 19 A configuration view of a coil forming stator windings according to Embodiment 4.

FIG. 20 A view showing a state in which the coil has been inserted into a stator core according to Embodiment 4, the state being observed from the top of the stator core.

FIG. 21 A view showing the state in which the coil has been inserted into the stator core according to Embodiment 4, the state being observed from the bottom of the stator core.

FIG. 22 A view showing the state in which the coil has been inserted into the stator core according to Embodiment 4, the state being observed from a side of the stator core.

FIG. 23 A view for explaining bending angles and dimensions of a conductor wire forming the coil according to Embodiment 4.

FIG. 24 A configuration view of windings for each phase in the stator in which coils have been inserted into the stator core in order to form a stator winding of a rotary electrical machine according to Embodiment 4.

FIG. 25 A view showing a state in which a coil has been inserted into a stator core according to Embodiment 5, the state being observed from the top of the stator core.

FIG. 26 A view showing the state in which the coil has been inserted into the stator core according to Embodiment 5, the state being observed from the bottom of the stator core.

FIG. 27 A view showing the state in which the coil has been inserted into the stator core according to Embodiment 5, the state being observed from a side of the stator core.

FIG. 28 A view showing a state in which a coil has been inserted into a stator core according to Embodiment 6, the state being observed from the top of the stator core.

FIG. 29 A view showing the state in which the coil has been inserted into the stator core according to Embodiment 6, the state being observed from the bottom of the stator core.

FIG. 30 A view showing the state in which the coil has been inserted into the stator core according to Embodiment 6, the state being observed from a side of the stator core.

FIG. 31 A view showing a state in which a coil has been inserted into a stator core according to a modification of Embodiments 1 to 6, the state being observed from the top of the stator core.

FIG. 32 A view showing a state in which a coil has been inserted into a stator core according to a modification of Embodiments 1 to 6, the state being observed from the top of the stator core.

FIG. 33 A view showing a state in which a coil has been inserted into a stator core according to a modification of Embodiments 1 to 6, the state being observed from the top of the stator core.

FIG. 34 A configuration view showing a coil bundle forming stator windings according to a modification of Embodiments 1 to 6.

FIG. 35 A view showing a state in which a coil bundle has been inserted into a stator core according to a modification of Embodiments 1 to 6, the state being observed from the top of the stator core.

FIG. 36 A configuration view showing a coil group forming stator windings according to a modification of Embodiments 1 to 6.

FIG. 37 A configuration view of windings for each phase in a stator in which coils have been inserted into a stator core according to Embodiment 7.

FIG. 38 A view in which a coil end portion is observed from the inside of the stator core in a state where the coils have been inserted into the stator core according to Embodiment 7.

FIG. 39 A view in which the coil end portion is observed from the inside of the stator core in a state where the coils have been inserted into the stator core according to Embodiment 7.

FIG. 40 Views showing a coil forming stator windings of a rotary electrical machine according to Embodiment 7.

FIG. 41 A view in which the coil end portion is observed from the inside of the stator core in a state where the coil has been inserted into the stator core according to Embodiment 7.

FIG. 42 Views showing a coil forming stator windings of a rotary electrical machine according to Embodiment 8.

FIG. 43 A view in which a coil end portion is observed from the inside of a stator core in a state where the coil has been inserted into the stator core according to Embodiment 8.

FIG. 44 A view in which a coil end portion is observed from the inside of a stator core in a state where a coil has been inserted into the stator core according to the background art.

### MODE FOR CARRYING OUT THE INVENTION

Rotary electrical machines according to embodiments will be described below in detail with reference to the drawings. Incidentally, the invention is not limited to the embodiments. The rotary electrical machines are electric motors or power generators. It will go well if each rotary electrical machine is either an electric motor or a power generator.

### Embodiment 1

A rotary electrical machine according to Embodiment 1 will be described.

The rotary electrical machine has a stator and a rotor. The rotor rotates relatively to the stator, and transmits rotational power to a mechanical device (not shown) through a shaft (not shown) fixed to the rotor so as to operate the mechanical device. The rotary electrical machine is, for example, a permanent magnet type rotary electrical machine or an induction type rotary electrical machine. For example, a winding structure in the stator is devised in the rotary electrical machine.

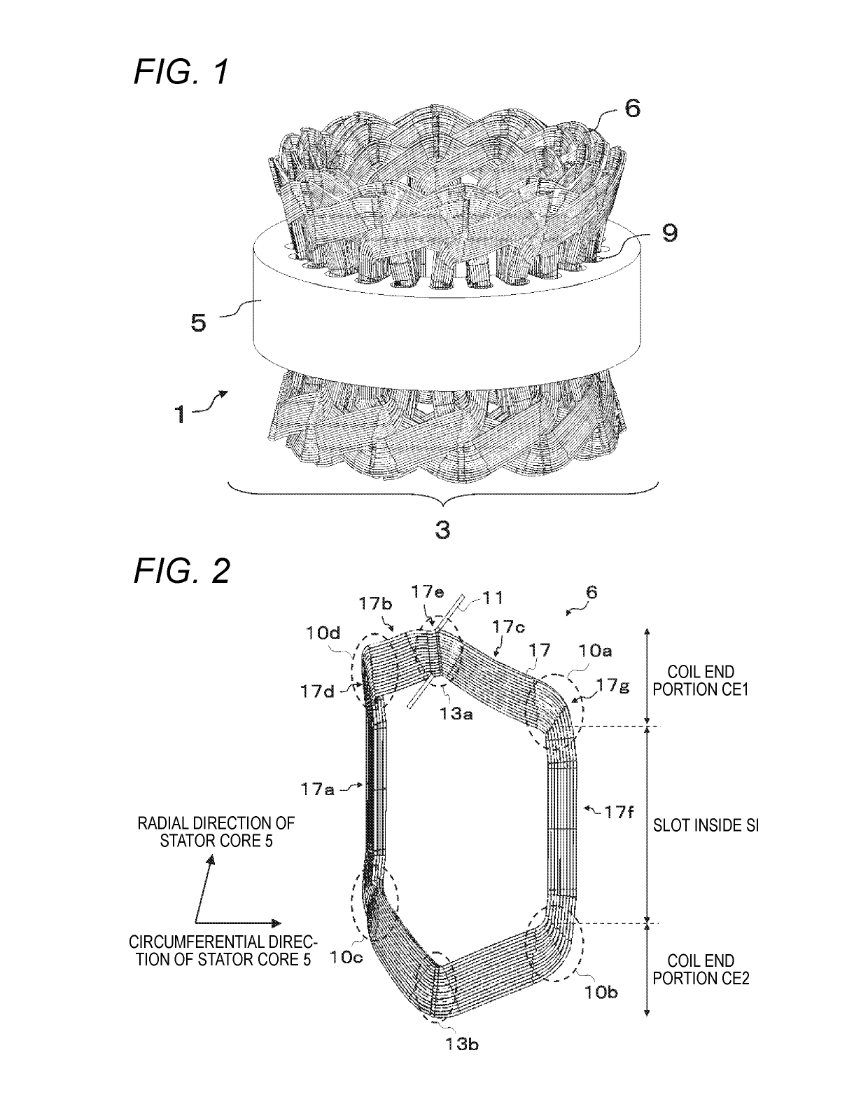

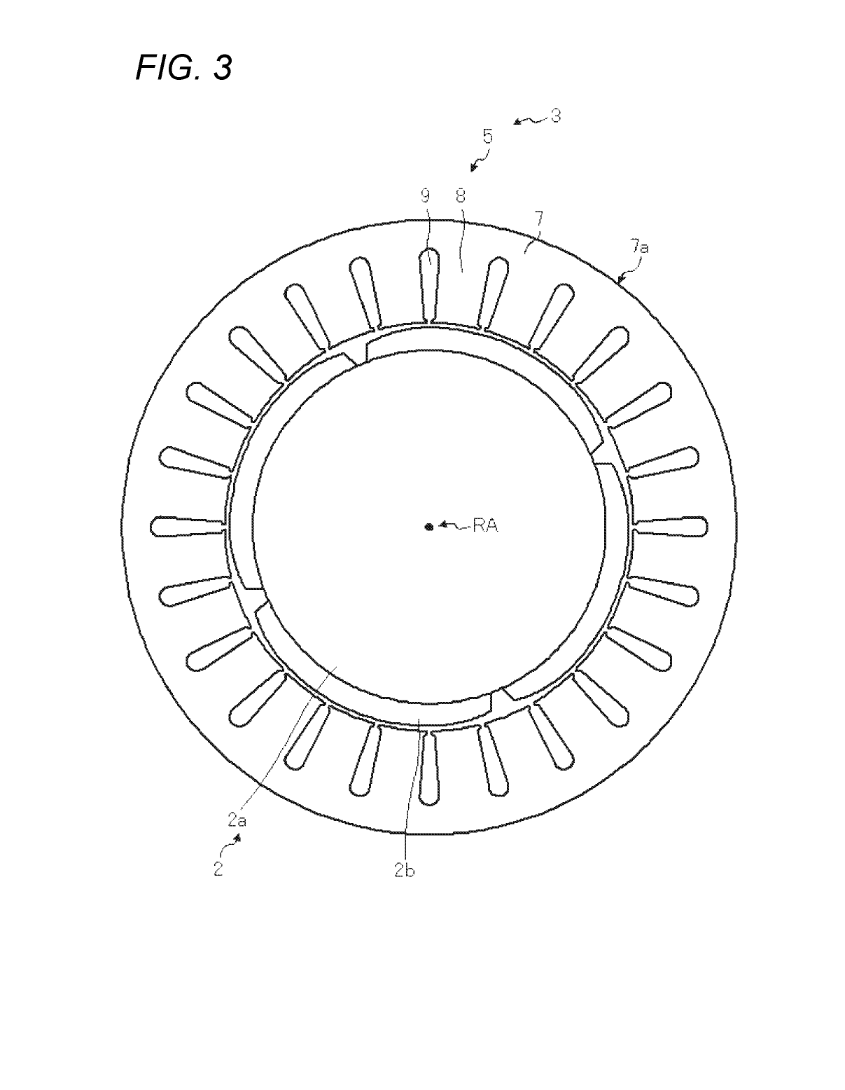

Specifically, the rotary electrical machine has a configuration shown in FIG. 1 to FIG. 3. FIG. 1 is a perspective view showing configurations of a stator core and stator windings in the rotary electrical machine. FIG. 2 is a perspective view showing a configuration of a coil in the stator windings. FIG. 3 is a view showing the configuration in which the rotor and the stator core are observed from a direction of a rotation axis RA. In FIG. 1 to FIG. 3, a rotary electrical machine that, for example, has 4 poles, 24 slots, 3 phases, and 2 slots in each pole and each phase is shown as a rotary electrical machine 1 by way of example. In addition, stator windings are not shown in FIG. 3, in order to simplify the illustration.

The rotary electrical machine 1 has a rotor 2 and a stator 3 as shown in FIG. 1 and FIG. 3. The rotor 2 has a rotor core 2a and a plurality of permanent magnets 2b. The rotor core 2a is formed to be concentric with the shaft. For example, the rotor core 2a has a columnar shape having a rotation axis RA extending along the shaft. The permanent magnets 2b are, for example, disposed along the circumferential surface of the rotor core 2a. Incidentally, a case where the rotor 2 is a permanent magnet type rotor is shown in FIG. 3 by way of example. However, the rotor 2 may be a cage type rotor that is formed in a cage shape and out of a conductor such as copper.

The stator 3 is formed to receive the rotor 2 while parting from the rotor 2. For example, the stator 3 has a stator core 5 and stator windings 6.

The stator core 5 is formed to be concentric with the shaft. For example, the stator core 5 has a cylindrical shape with a rotation axis RA extending along the shaft. The stator core 5 is, for example, formed out of a lamination of electromagnetic steel sheets or the like.

For example, the stator core 5 has a core back 7, a plurality of teeth 8 and a plurality of slots 9 as shown in FIG. 3. The core back 7 is annular. For example, the core back 7 has a cylindrical shape. Each of the teeth 8 extends axially from the core back 7 and on the rotation axis RA. The teeth 8 are arrayed on the rotation axis RA side of the core back 7 and in a direction along a circumferential surface 7a of the core back 7 (that is, in a circumferential direction). The slots 9 are formed between circumferentially adjacent ones of the teeth 8 respectively.

The stator windings 6 are wound on the stator core so that a coil of the same phase can appear in every two slots in the stator core 5. For example, the stator windings 6 circumferentially protected by insulating paper or the like are inserted into the slots 9. In the stator windings 6, each coil 17 is formed as a bundle of conductor wires 11. At least one coil 17 is disposed inside the slots 9. Terminals of the coil 17 are connected by a method of welding or the like. Thus, the stator windings 6 are formed.

In the stator windings 6, a coil 17 having a similar shape is formed for each phase. For example, the coil 17 shown in FIG. 2 is formed. The coil 17 is wound and inserted into the slots 9 of the stator core 5 so that windings of the coil 17 to be inserted into corresponding-phase slots 9 adjacent to each other can be put on top of each other. The coil 17 is formed as a bundle of conductor wires 11.

Specifically, the coil 17 has a first conductor wire group 17a, a second conductor wire group 17b, a first bent portion 17d, a third conductor wire group 17c, a second bent portion 17e, a fourth conductor wire group 17f, and a third bent portion 17g.

The first conductor wire group 17a is disposed in a slot inside SI and m stages (m is an integer of 2 or larger) of the conductor wires 11 are be arranged in the radial direction of the stator core 5.

In the second conductor wire group 17b, the arrangement of the first conductor wire group 17a is changed into n stages (n is an integer of 1 or larger) in the radial direction of the stator core 5 in a coil end portion CE1. In the second conductor wire group 17b, the conductor wires 11 are, for example, disposed from the first stage to the n-th stage in the radial direction of the stator core 5 in the coil end portion CE1.

In the first bent portion 17d, the conductor wires 11 are bent in the boundary between the slot inside SI and the coil end portion CE1 so that the first conductor wire group 17a and the second conductor wire group 17b can form an angle θ (90°<θ<180°). That is, an arrangement changing portion 10d including the first bent portion 17d changes the winding arrangement from the arrangement of the first conductor wire group 17a in the slot inside SI to the arrangement of the second conductor wire group 17b in the coil end portion CE1.

In the third conductor wire group 17c, the arrangement of the second conductor wire group 17b is changed into stages from the (m−n+1)th stage to the m-th stage in the radial direction of the stator core 5 in the coil end portion CE1. In the third conductor wire group 17c, the conductor wires 11 are disposed from the (m−n+1)th stage to the m-th stage in the radial direction of the stator core 5 in the coil end portion CE1.

In the second bent portion 17e, the conductor wires 11 are bent in the coil end portion CE1 so that the second conductor wire group 17b and the third conductor wire group 17c can form an angle θ′(=360°−(θ+θ″)). That is, a passing area changing portion 13a including the second bent portion 17e changes the winding arrangement from the arrangement (passing area in the radial direction) of the second conductor wire group 17b in the coil end portion CE1 to the arrangement (passing area in the radial direction) of the third conductor wire group 17c in the coil end portion CE1.

In the fourth conductor wire group 17f, m stages (m is an integer of 2 or larger) of the conductor wires 11 in the radial direction of the stator core 5 are disposed in the slot inside SI.

In the third bent portion 17g, the conductor wires 11 are bent in the boundary between the coil end portion CE1 and the slot inside SI so that the third conductor wire group 17c and the fourth conductor wire group 17f can form an angle θ″ (90°<θ″<180°). That is, an arrangement changing portion 10a including the third bent portion 17g changes the winding arrangement from the arrangement of the third conductor wire group 17c in the coil end portion CE1 to the arrangement of the fourth conductor wire group 17f in the slot inside SI.

Here, the numbers of stages m and n satisfy the following Expression 1.

n/m≦1/2 Expression 1

For example, in FIG. 2, the coil 17 is constituted by the conductor wires 11 measuring two stages (in the radial direction of the stator core 5) by eight lines (in the circumferential direction of the stator core 5) in the slot inside SI. The number in the radial direction and the number in the circumferential direction can be, for example, defined as follows.

For example, in the case shown in FIG. 2, the coil 17 changes its winding arrangement between the slot inside SI and the coil end portion CE1 (in the arrangement changing portion 10d including the first bent portion 17d). As a result, the bundle of the conductor wires 11 measuring two stages (in the radial direction of the stator core 5) by eight lines (in the circumferential direction of the stator core 5) in the slot inside SI is arranged into a bundle measuring one stage (in the radial direction of the stator core 5) by sixteen lines (in the circumferential direction of the stator core 5) in the coil end portion CE1. At the same time, the conductor wires 11 are bent at the angle θ (for example, 120° in FIG. 2) in the first bent portion 17d.

Next, in the coil end portion CE1, for example, the arrangement of the conductor wire 11 disposed at the first stage in the radial direction of the stator core 5 is, for example, changed into the second stage in the radial direction of the stator core 5 (in the passing area changing portion 13a including the second bent portion 17e) in order to be prevented from interfering with any winding of another phase (any coil 17 of another phase). Also on this occasion, the conductor wire 11 is bent at the angle θ′ (for example, 120° in FIG. 2) between before and after changing the arrangement, that is, in the second bent portion 17e.

After that, when coming back from the coil end portion CE1 to the slot inside SI again, the winding arrangement is changed (in the arrangement changing portion 10a including the third bent portion 17g). As a result, the bundle of the conductor wires 11 measuring one stage (in the radial direction of the stator core 5) by sixteen lines (in the circumferential direction of the stator core 5) in the coil end portion CE1 is arranged into a bundle measuring two stages (in the radial direction of the stator core 5) by eight lines (in the circumferential direction of the stator core 5) in the slot inside SI. Also on this occasion, the conductor wires 11 are bent at the angle θ″ (for example, 120° in FIG. 2).

When the coil 17 is formed in this manner, the coil shape in the coil end portion CE1 is triangular. In addition, though not explained, the arrangement of the conductor wires 11 are also changed in the lower half of the coil 17 in the same manner. As a whole, the coil 17 has a hexagonal shape including a triangular shape in the coil end portion CE1, a quadrangular shape in the slot inside SI, and a triangular shape in the coil end portion CE2.

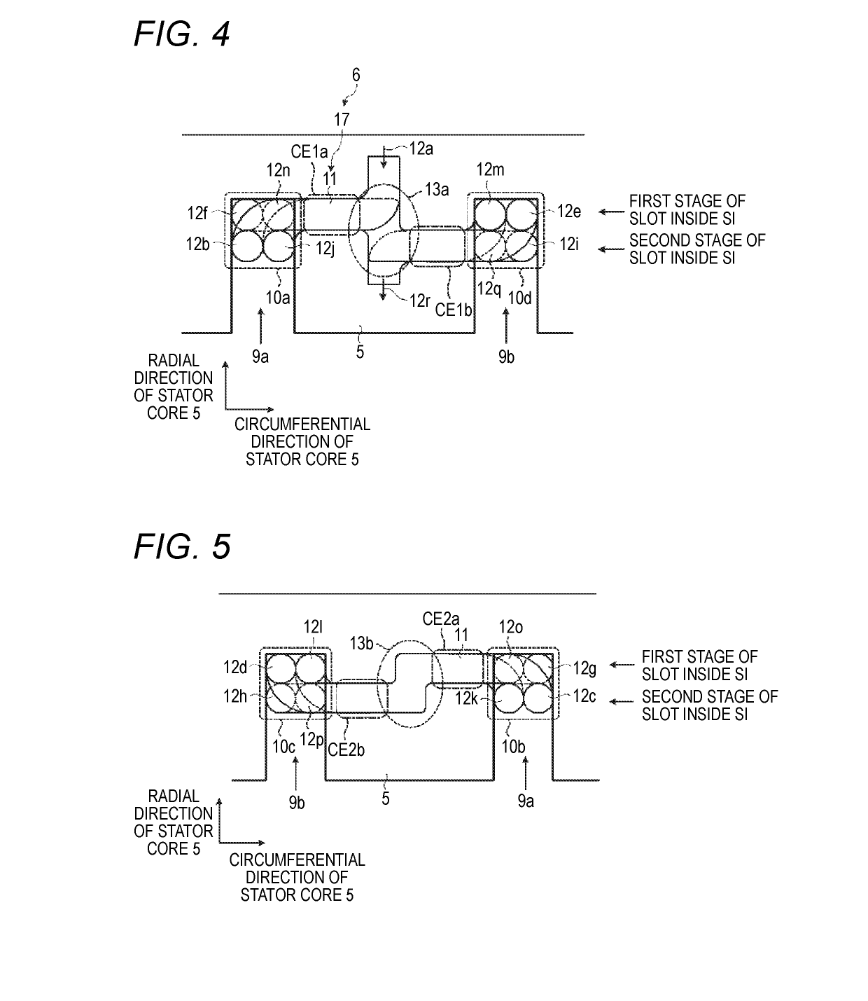

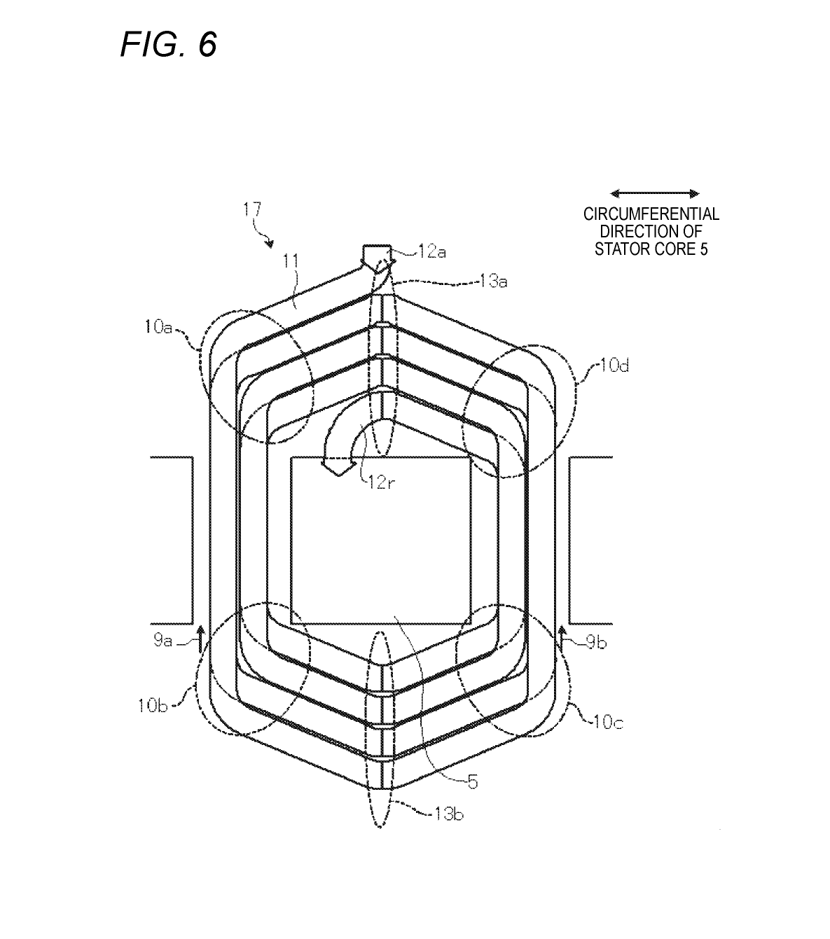

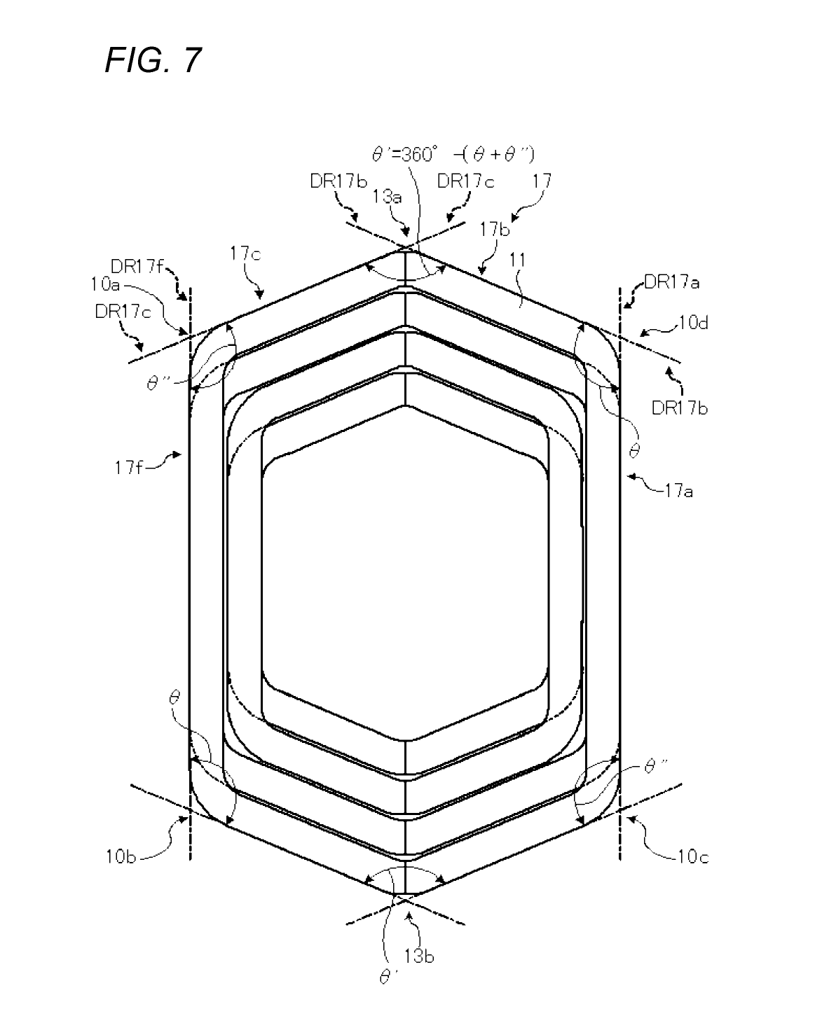

FIG. 4 is a view showing a state in which a coil has been inserted into a stator core, the state being observed from the top of the stator core (the direction of the rotation axis RA). FIG. 5 is a view showing the state in which the coil has been inserted into the stator core, the state being observed from the bottom of the stator core. FIG. 6 is a view showing the state in which the coil has been inserted into the stator core, the state being observed from a side of the stator core (the direction facing the rotation axis RA). FIG. 7 is a view for explaining bending angles of a conductor wire forming the coil. Next, the parts where the winding arrangement is changed in the coil 17 will be described in detail with reference to FIG. 4 to FIG. 7.

FIG. 4 to FIG. 6 show a state in which one coil 11 measuring two stages (in the radial direction of the stator core 5) by two lines (in the circumferential direction of the stator core 5) in the slot inside SI has been inserted by way of example. How to wind the conductor wires 11 to form the coil 17 on this occasion will be described using a position 12a to a position 12r by way of example.

In the coil 17, winding the conductor wire 11 is started at an intermediate position (position 12a) between two slots 9a and 9b. The conductor wire 11 passing through an area CE1a in the coil end portion CE1 corresponding to the first stage of the slot inside SI approaches the slot 9a. After that, the arrangement of the conductor wire 11 is changed (in the arrangement changing portion 10a) so that the conductor 11 can enter a position 12b (see FIG. 4) in the second stage of the slot inside SI. When this portion is observed from a side, the conductor wire 11 is bent at the angle θ″ (see FIG. 6 and FIG. 7).

The conductor wire 11 passing through the slot inside SI comes out from a position 12c (see FIG. 5). Then the arrangement of the conductor wire 11 is changed (in an arrangement changing portion 10b) so that the conductor wire 11 can come out to an area CE2a in the coil end portion CE2 (see FIG. 2) corresponding to the first stage of the slot inside SI. When this portion is observed from a side, the conductor wire 11 is bent at the angle θ (see FIG. 6 and FIG. 7).

The conductor wire 11 goes toward the slot 9b on the opposite side. When the conductor wire 11 reaches the intermediate position between the slot 9a and the slot 9b, the arrangement of the conductor wire 11 is changed (in a passing area changing portion 13b) so that the conductor wire 11 can pass through an area CE2b in the coil end portion CE2 (see FIG. 2) corresponding to the second stage of the slot inside SI. When this portion is observed from a side, the conductor wire 11 is bent at the angle θ′ (see FIG. 6 and FIG. 7).

When the conductor wire 11 approaches the slot 9b, the arrangement of the conductor wire 11 is changed (in an arrangement changing portion 10c) so that the conductor wire 11 can enter a position 12d in the first stage of the slot inside SI. When this portion is observed from a side, the conductor wire 11 is bent at the angle θ″ (see FIG. 6 and FIG. 7).

The conductor wire 11 passing through the slot inside SI comes out from a position 12e. Then the arrangement of the conductor wire 11 is changed (in the arrangement changing portion 10d) so that the conductor wire 11 can come out to an area CE1b in the coil end portion CE1 (see FIG. 2) corresponding to the second stage of the slot inside SI. When this portion is observed from a side, the conductor wire 11 is bent at the angle θ.

The conductor wire 11 goes toward the slot 9a on the opposite side. When the conductor wire 11 reaches the intermediate position between the slot 9a and the slot 9b, the arrangement of the conductor wire 11 is changed (in the passing area changing portion 13a) so that the conductor wire 11 can pass through the area CE1a in the coil end portion CE1 (see FIG. 2) corresponding to the first stage of the slot inside SI again. When this portion is observed from a side, the conductor wire 11 is bent at the angle θ′.

In this manner, the conductor wire 11 forming the coil 17 is wound by one turn. Subsequently in the same manner, the conductor wire is wound in the order of a position 12f, a position 12g, a position 12h, . . . , a position 12p, and a position 12q. Incidentally, in side view, four conductor wires 11 are arranged side by side in each coil end portion CE1, CE2. The conductor wires 11 are, for example, disposed so that the conductor wire 11 wound in the third turn can be located on the inner side of the conductor wire 11 wound in the second turn as shown in FIG. 6.

In addition, the arrangement changing portions 10a to 10d change the arrangement of the conductor wires 11 entering and leaving the slot inside SI when the conductor wires 11 are wound in the first and third turns, but actually do not change the arrangement when the conductor wires are wound in the second or fourth turn. In the second or fourth turn, for example, the conductor wire 11 coming from the area CE1a in the coil end portion CE1 corresponding to the first stage of the slot inside SI may directly enter the position 12f or 12n in the first stage of the slot inside SI. Or, for example, the conductor wire 11 coming from the position 12o or 12g in the first stage of the slot inside SI may come out to the area CE2a in the coil end portion CE2 corresponding to the first stage of the slot inside SI. Or, for example, the conductor wire 11 coming from the area CE2b in the coil end portion CE2 corresponding to the second stage of the slot inside SI may directly enter the position 12h or 12p in the second stage of the slot inside SI. Or, for example, the conductor wire 11 coming from the position 12q or 12i in the second stage of the slot inside SI may come out to the area CE1b in the coil end portion CE1 corresponding to the second stage of the slot inside SI.

Finally, winding the conductor wire 11 is terminated in the intermediate position (position 12r) between the two slots 9a and 9b. Thus, the coil 17 having different arrangement of the conductor wire 11 between the slot inside SI and each coil end portion CE1, CE2 can be formed.

Incidentally, the aforementioned method is exemplary to obtain the coil 17 having different arrangement of the conductor wires 11 between the slot inside SI and each coil end portion CE1, CE2. The coil 17 does not have to be formed in this procedure. In addition, the method in which winding the coil 17 is started at an intermediate position (position 12a) between the two slots 9a and 9b and ended in a similar position (position 12r) is used in this description. However, winding the coil 17 does not have to be started at the position or ended at the position. As will be described later, the intermediate position between the slot 9a and the slot 9b corresponds to an apex of the coil end portion CE1, CE2 having a triangular shape in side view. Accordingly, when a plurality of coils 17 are connected, there is an advantage that a line for connecting the coils 17 hardly interferes with windings of another phase.

In addition, FIGS. 4 and 5 show that each passing area changing portion 13a, 13b has a crank shape with right angles when the arrangement of the conductor wires 11 are changed. However, the passing area changing portion 13a, 13b does not have to have a crank shape with right angles if the purpose of changing the area CE1a, CE1b where the conductor wires 11 in the coil end portion CE1 pass can be attained. For example, the passing area changing portion 13a, 13b may be formed in a straight line with no crank so that the area can be changed gently. In the same manner, although each arrangement changing portion 10a to 10d is formed in a crack shape with right angles when the arrangement of the conductor wires 11 are changed between the slot inside SI and each coil end portion CE1, CE2, the shape does not have to be a crank shape with right angles if the purpose of changing the arrangement of the conductor wires 11 can be attained.

The bending angles of the conductor wires 11 forming the coil 17 will be described with reference to FIG. 7.

For example, the bending angle θ″ in the arrangement changing portion 10a is an angle between an extending direction DR17c of the third conductor wire group 17c and an extending direction DR17f of the fourth conductor wire group 17f, which is an angle facing the inside of the coil 17. Since the coil 17 has a hexagonal shape in side view, the angle θ″, for example, satisfies the following Expression 2.

90°<θ″<180° Expression 2

The angle θ″ satisfying Expression 2 is, for example, 120°.

For example, the bending angle θ in the arrangement changing portion 10d is an angle between an extending direction DR17a of the first conductor wire group 17a and an extending direction DR17b of the second conductor wire group 17b, which is an angle facing the inside of the coil 17. The angle θ satisfies the following Expression 3.

90°<θ<180° Expression 3

The angle θ satisfying Expression 3 is, for example, 120°.

For example, the bending angle θ′ in the passing area changing portion 13a is an angle between the extending direction DR17b of the second conductor wire group 17b and the extending direction DR17c of the third conductor wire group 17c, which is an angle facing the inside of the coil 17. The angle θ′ satisfies the following Expression 4.

θ′=360°−(θ+θ″) Expression 4

For example, when the coil 17 has a symmetric shape as shown in FIG. 6 and FIG. 7, the following Expression 5 is established.

θ=θ″ Expression 5

When Expression 5 is substituted into Expression 4, the following Expression 6 is obtained.

θ′=360°−2θ Expression 6

For example, when the angle θ=θ″ is 120°, the angle θ′ is 120°.

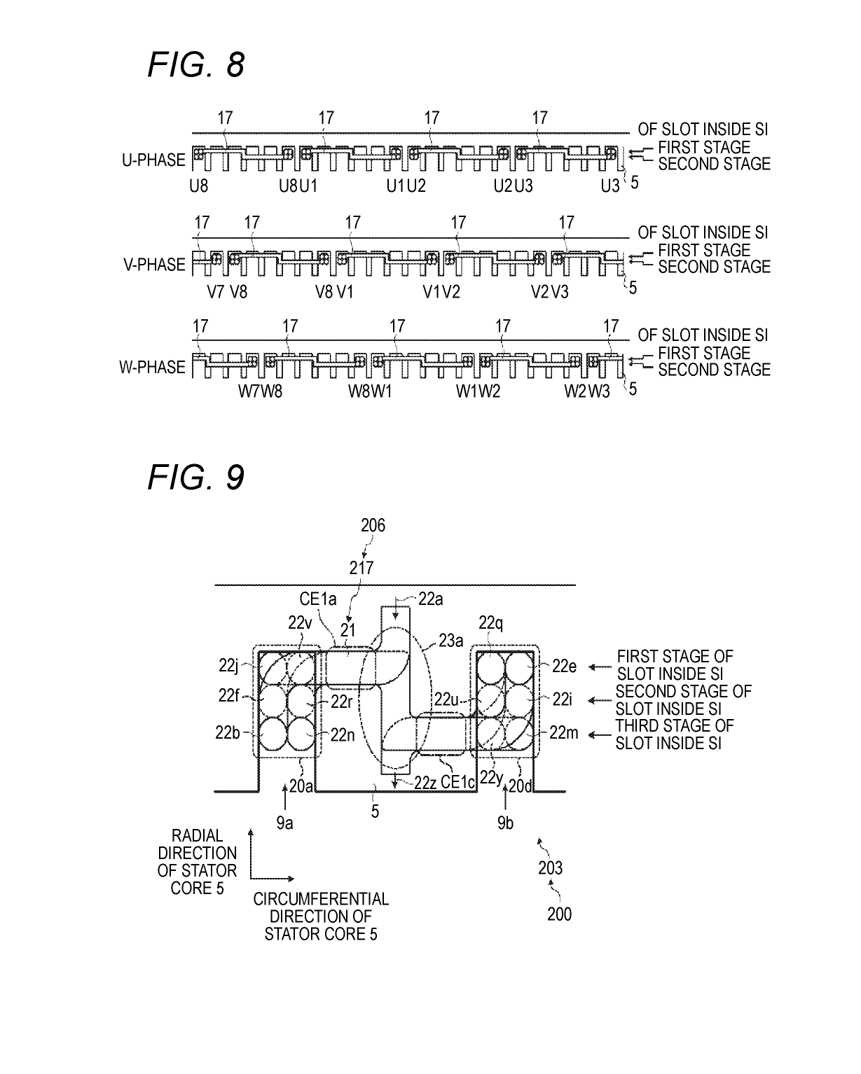

FIG. 8 shows a configuration view of windings for each phase in the stator in which coils have been inserted into the stator core in order to form stator windings of a rotary electrical machine. FIG. 8 shows a case in which a coil of one and the same phase appears in every two slots when the number of slots in each pole and each phase is two (8 poles and 48 slots). Each coil 17 is wound so that windings of the coil 17 to be inserted into corresponding-phase slots 9 adjacent to each other can be put on top of each other and inserted into the slots 9 of the stator core 5 at an interval of 4 slots. Incidentally, the stator core 5 in FIG. 8 is illustrated as a straight line shape for the sake of easiness of explanation. In addition, halfway parts of the stator core 5 are not shown in FIG. 8.

For example, V-phase windings V8 have a coil 17 in which a coil 17 of U-phase windings U8 has been shifted circumferentially in the right direction of FIG. 8 by two slots. For example, W-phase windings W8 have a coil 17 in which the coil 17 of the V-phase windings V8 has been shifted circumferentially in the right direction of FIG. 8 by two slots. That is, when the coils 17 in FIG. 8 are observed at the right end, the arrangement pattern of the U-phase, V-phase and W-phase coils 17 distributed in two-slot pitches is repeated in a 6-slot cycle. Each coil 17 is mounted over 6 slots in the coil end portion CE1 so that the coil 17 can pass through an area of the first stage in the left three slots and pass through an area of the second stage in the right three slots.

When the stator windings 6 are formed in the aforementioned method, the distance between adjacent ones of the slots 9 can be made short (for example, shortest) so that the circumferential length of each coil 17 can be made short. When the stator windings 6 are formed using the coils 17 whose circumferential lengths are short, there is a considerable advantage that the total circumferential length of the stator windings 6 can be made short enough to reduce the resistance value of the windings, leading to reduction in motor loss and improvement in motor operating efficiency.

If coils connecting the slots 9 straightly in parallel with the circumferential direction are disposed periodically in each coil end portion CE1, CE2 to form a winding circuit, U-phase, V-phase and W-phase windings will interfere with one another at many places. When the stator windings take a detour to avoid the interference, the total circumferential length of the stator windings will be increased or the height of the coil end portion will be increased. That is, since the height of the coil end portion is apt to be increased, it is likely that the conductor wire length may be increased, and the winding resistance may be increased, that is, the copper loss may be increased and the efficiency may be lowered.

On the other hand, according to the embodiment, the aforementioned coils 17 are used so that the conductor wires 11 in the left half of the coil end portion CE1 can be collected in the area CE1a (see FIG. 4) corresponding to the first stage of the slot inside SI, and the conductor wires 11 in the right half of the coil end portion CE1 can be collected in the area CE1b (see FIG. 4) corresponding to the second stage of the slot inside SI. As a result, the U-phase, V-phase and W-phase windings can be prevented from interfering with one another easily. Although there appears in FIG. 8 an area where the coils 17 inserted into the U-phase, the V-phase and the W-phase overlap one another, each coil 17 in each coil end portion CE1, CE2 is formed in a triangle in fact. The center (a part like a crank shape in the passing area changing portion 13a, 13b) of the coil 17 is an apex of the triangle. Thus, the U-phase, V-phase and W-phase windings can be prevented from mechanically interfering with one another easily. In this manner, the height of the coil end portion CE1, CE2 can be reduced so that the stator windings 6 using the coils 17 whose circumferential lengths are short can be formed.

Next, the operation and effect of Embodiment 1 will be described by way of example.

For example, the first effect will be described. For example, the arrangement of the conductor wires 11 are changed between the slot inside SI and each coil end portion CE1, CE2 (in the arrangement changing portions 10a to 10d), and the arrangement of the conductor wires 11 are changed in the radial direction of the stator core 5 in the coil end portion CE1, CE2 (in the passing area changing portions 13a and 13b). Thus, windings of one phase can be prevented from interfering with windings of another phase easily in the coil end portion CE1, CE2, so that the height of the coil end portion CE1, CE2 can be reduced.

Incidentally, as shown in FIG. 2 by way of example, the arrangement in the bundle of the conductor wires 11 having two stages (in the radial direction of the stator core 5) in the slot inside SI is changed to one stage (in the radial direction of the stator core 5) in the coil end portion CE1, CE2, and bent portions are provided so that the coil 17 as a whole can be formed in a hexagonal shape. In this case, a useless space in which no conductor wires 11 are disposed can be made small (for example, substantially negligible) in the coil end portion CE1, CE2. Thus, the arrangement density (space factor) of the conductor wire 11 can be improved effectively (for example, so that the conductor wires 11 can be disposed most densely). In this manner, the coil end portion CE1, CE2 can be miniaturized as a whole.

The second advantage will be described. For example, in the stator windings 5, the coils 17 having the same shape may be used for all the U phase, the V phase and the W phase. Thus, the efficiency in the work of forming the windings can be improved, and the winding length for each phase can be made uniform (for example, equal). Therefore, unbalance in winding resistance value among the phases can be suppressed within an allowable range. It is therefore possible to reduce torque ripples to thereby reduce vibration.

In this manner, in the rotary electrical machine 1 according to Embodiment 1, windings for each phase in the stator windings 6 is formed out of at least one coil 17. In each coil 17, the first conductor wire group 17a is disposed in m stages (m is an integer of 2 or larger) in the radial direction of the stator core 5 in the slot inside SI. In the second conductor wire group 17b, the arrangement of the first conductor wire group 17a is changed into n stages (n is an integer of 1 or larger) in the radial direction of the stator core 5 in the coil end portion CE1. The first bent portion 17d is bent so that the first conductor wire group 17a and the second conductor wire group 17b can form the angle θ smaller than 180° in the boundary between the slot inside SI and the coil end portion CE1. In the third conductor wire group 17c, the arrangement of the second conductor wire group 17b disposed from the first stage to the n-th stage in the radial direction of the stator core 5 is changed from the (m−n+1)th stage to the m-th stage in the radial direction of the stator core 5 in the coil end portion CE1. The second bent portion 13a is bent so that the second conductor wire group 17b and the third conductor wire group 17c can form the angle θ′ smaller than 180° in the coil end portion CE1. The numbers of stages m and n satisfy:

n/m≦1/2

Thus, in each coil 17 forming windings of each phase, for example, the arrangement of the conductor wires 11 can be changed between the slot inside SI and each coil end portion CE1, CE2 (in the arrangement changing portions 10a to 10d), and the arrangement of the conductor wires 11 can be changed in the radial direction of the stator core 5 in the middle of the coil end portion CE1, CE2 (in the passing area changing portions 13a and 13b). For example, the conductor wires 11 in the left half of the coil end portion CE1 can be collected in the area CE1a (see FIG. 4) corresponding to the first stage of the slot inside SI, and the conductor wires 11 in the right half of the coil end portion CE1 can be collected in the area CE1b (see FIG. 4) corresponding to the second stage of the slot inside SI. As a result, when the coils 17 having similar shapes are used for windings of the respective phases, windings of one phase can be prevented from interfering with windings of another phase easily in the coil end portion CE1, CE2, so that the height of the coil end portion CE1, CE2 can be reduced. That is, mechanical interference among the windings of the respective phases in the coil end portion CE1, CE2 can be reduced, and the winding length for each phase can be made uniform (for example, equal). As a result, the outer diameter of the coil end portion can be reduced, and unbalance in winding resistance value among the phases can be suppressed within an allowable range.

In addition, according to Embodiment 1, the coils 17 having similar shapes can be used for windings of respective phases. Thus, the work of connecting the windings can be simplified, and the manufacturing cost of the rotary electrical machine 1 can be reduced.

In addition, according to Embodiment 1, for example, in view from the direction of the rotation axis RA, the second bent portion 17e has a crank shape to change the arrangement in the radial direction between the second conductor wire group 17b and the third conductor wire group 17c. Thus, for example, the conductor wires 11 in the left half of the coil end portion CE1 can be collected in the area CE1a (see FIG. 4) corresponding to the first stage of the slot inside SI, and the conductor wires 11 in the right half of the coil end portion CE1 can be collected in the area CE1b (see FIG. 4) corresponding to the second stage of the slot inside SI. As a result, when the coils 17 having similar shapes are used for windings of the respective phases, windings of one phase can be prevented from interfering with windings of another phase easily in the coil end portion CE1, CE2.

In addition, according to Embodiment 1, in each coil 17 forming windings of each phase, the fourth conductor wire group 17f is disposed to have m stages (m is an integer of 2 or larger) in the radial direction of the stator core 5 in the slot inside SI. The third bent portion 17g is bent so that the third conductor wire group 17c and the fourth conductor wire group 17f can form the angle θ smaller than 180° in the boundary between the coil end portion CE1 and the slot inside SI. The angle θ″ satisfies:

90°<θ″<180°

The angle θ satisfies:

90°<θ<180°

The angle θ′ satisfies:

θ′=360°−(θ+θ″)

Thus, each coil 17 forming windings of each phase can be, for example, formed in a hexagonal shape. As a result, it is easy to arrange the coils 17 so that mechanical interference can be reduced among the windings of the respective phases in each coil end portion CE1, CE2 while the coils 17 having similar shapes are used for the windings of the respective phases.

In addition, according to Embodiment 1, the angle θ and the angle θ″ are, for example, equal to each other. The angle θ′ satisfies:

θ′=360°−2θ

Thus, each coil 17 forming windings of each phase can be formed in a hexagonal shape that is symmetric, for example, in view from a direction perpendicular to a side of the teeth 8 (see FIG. 6). As a result, unbalance in winding resistance value among the respective phases can be further suppressed.

### Embodiment 2

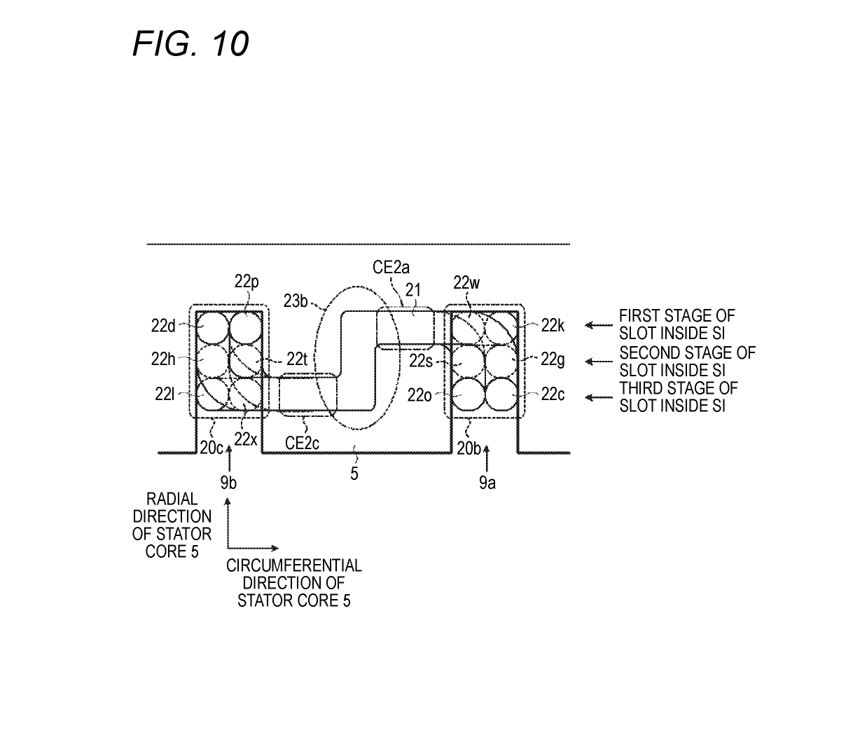

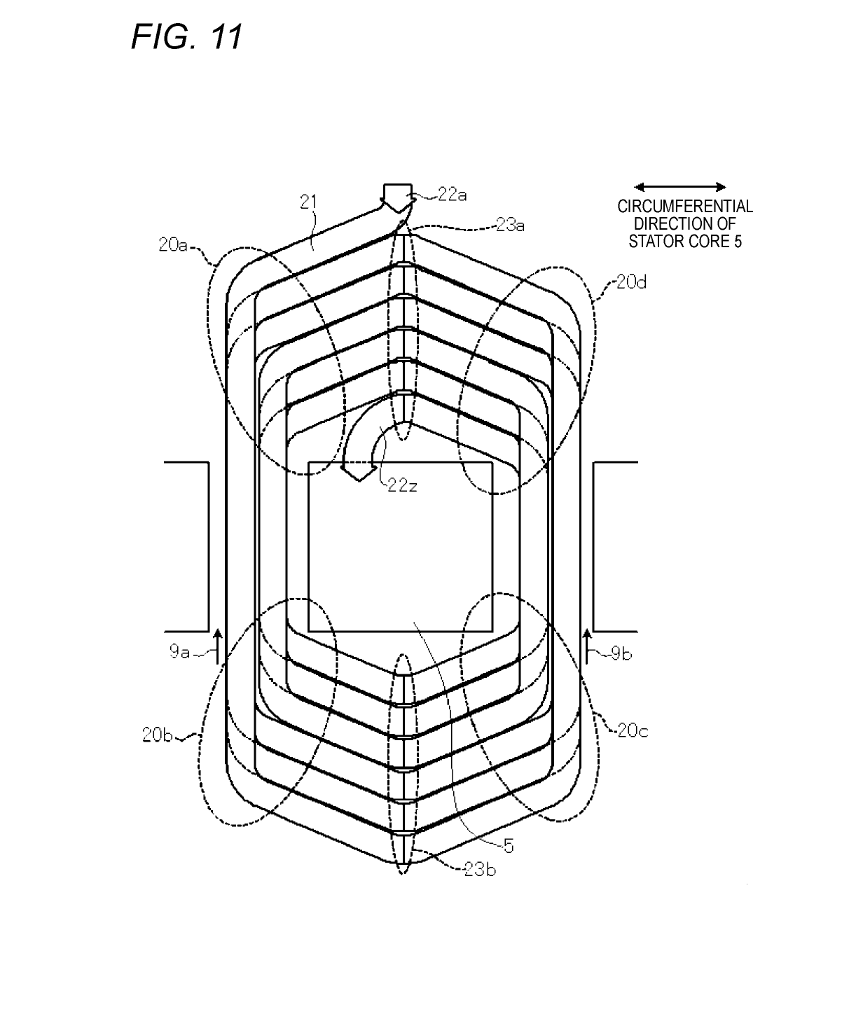

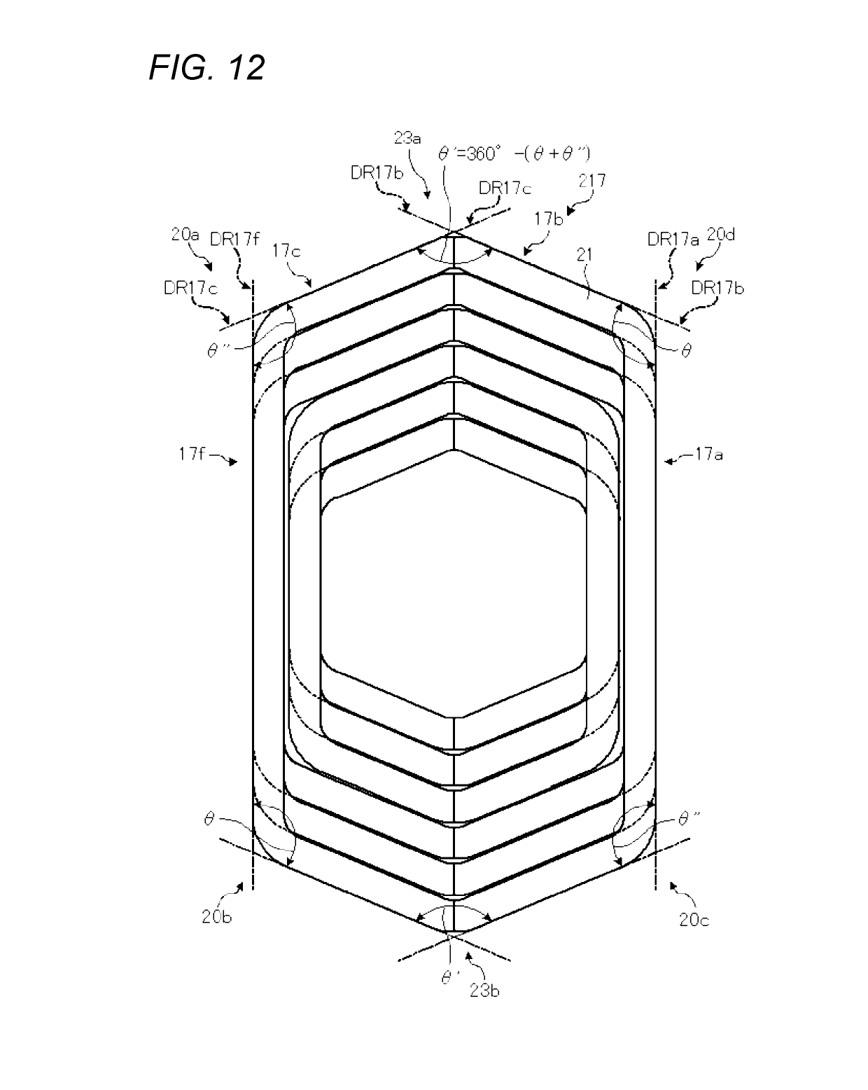

Next, a rotary electrical machine according to Embodiment 2 will be described. FIG. 9 is a view showing a state in which a coil has been inserted into a stator core, the state being observed from the top of the stator core. FIG. 10 is a view showing the state in which the coil has been inserted into the stator core, the state being observed from the bottom of the stator core. FIG. 11 is a view showing the state in which the coil has been inserted into the stator core, the state being observed from a side (surface facing a rotation axis RA) of the stator core. FIG. 12 is a view for explaining bending angles of a conductor wire forming the coil. The following description will be made mainly around different parts from Embodiment 1.

In Embodiment 1, exemplar description has been made about a coil in which the arrangement of the conductor wires 11 having two stages in the radial direction in the slot inside SI is changed into one stage in the radial direction in each coil end portion CE1, CE2. In Embodiment 2, exemplar description will be made about a coil in which the arrangement of conductor wires 21 having three stages in the radial direction in the slot inside SI is changed into one stage in the radial direction in each coil end portion CE1, CE2.

Specifically, in stator windings 206 of a stator 203 in a rotary electrical machine 200, the configuration of each coil 217 forming windings of each phase is different from that in Embodiment 1 at the following points as shown in FIG. 9 to FIG. 12.

FIG. 9 to FIG. 11 show a state in which one coil 217 measuring three stages (in the radial direction of the stator core 5) by two lines (in the circumferential direction of the stator core 5) in the slot inside SI has been inserted. How to wind a conductor wire to form the coil 217 on this occasion will be described using symbols from a position 22a to a position 22z by way of example.

In the coil 217, winding the conductor wire 21 is started at an intermediate position (position 22a) between two slots 9a and 9b. The conductor wire 21 passing through an area CE1a in the coil end portion CE1 (see FIG. 2) corresponding to the first stage of the slot inside SI approaches the slot 9a. After that, the arrangement of the conductor wire 21 is changed (in an arrangement changing portion 20a) so that the conductor 21 can enter a position 22b (see FIG. 9) in the third stage of the slot inside SI. When this portion is observed from a side, the conductor wire 21 is bent at an angle θ″ (see FIG. 11 and FIG. 12).

The conductor wire 21 passing through the slot inside SI comes out from a position 22c (see FIG. 10). Then the arrangement of the conductor wire 21 is changed (in an arrangement changing portion 20b) so that the conductor wire 21 can come out to an area CE2a in the coil end portion CE2 (see FIG. 2) corresponding to the first stage of the slot inside SI. When this portion is observed from a side, the conductor wire 21 is bent at an angle θ (see FIG. 11 and FIG. 12).

The conductor wire 21 goes toward the slot 9b on the opposite side. When the conductor wire 21 reaches the intermediate position between the slot 9a and the slot 9b, the arrangement of the conductor wire 21 is changed (in a passing area changing portion 23b) so that the conductor wire 21 can pass through an area CE2c in the coil end portion CE2 (see FIG. 2) corresponding to the third stage of the slot inside SI this time. When this portion is observed from a side, the conductor wire 21 is bent at an angle θ′ (see FIG. 11 and FIG. 12).

When the conductor wire 21 approaches the slot 9b, the arrangement of the conductor wire 21 is changed (in an arrangement changing portion 20c) so that the conductor wire 21 can enter a position 22d (see FIG. 10) in the first stage of the slot inside SI. When this portion is observed from a side, the conductor wire 21 is bent at the angle θ″ (see FIG. 11 and FIG. 12).

The conductor wire 21 passing through the slot inside SI comes out from a position 22e (see FIG. 9). Then the arrangement of the conductor wire 21 is changed (in an arrangement changing portion 20d) so that the conductor wire 21 can come out to an area CE1c in the coil end portion CE1 (see FIG. 2) corresponding to the third stage of the slot inside SI. When this portion is observed from a side, the conductor wire 21 is bent at the angle θ (see FIG. 11 and FIG. 12).

The conductor wire 21 goes toward the slot 9a on the opposite side. When the conductor wire 21 reaches the intermediate position between the slot 9a and the slot 9b, the arrangement of the conductor wire 21 is changed (in a passing area changing portion 23a) so that the conductor wire 21 can pass through the area CE1a in the coil end portion CE1 (see FIG. 2) corresponding to the first stage of the slot inside SI again. When this portion is observed from a side, the conductor wire 21 is bent at the angle θ′.

In this manner, the conductor wire 21 forming the coil 217 is wound by one turn. Subsequently in the same manner, the conductor wire 21 is wound in the order of a position 22f, a position 22g, a position 22h, . . . , a position 22x, and a position 22y. Incidentally, in side view, six conductor wires 21 are arranged side by side in each coil end portion CE1, CE2. The conductor wires 21 are disposed so that the conductor wire 21 wound in the third turn can be located on the inner side of the conductor wire 21 wound in the second turn as shown in FIG. 11.

In addition, the arrangement changing portions 20a to 20d change the arrangement of the conductor wires 21 entering and leaving the slot inside SI when the conductor wires 21 is wound in the first, second, fourth and fifth turns, but actually do not change the arrangement when the conductor wires 21 is wound in the third or sixth turn. For example, the conductor wires 21 coming from the area CE1a in the coil end portion CE1 corresponding to the first stage of the slot inside SI may directly enter the position 22j or 22v in the first stage of the slot inside SI. Or, for example, the conductor wires 21 coming from the position 22w or 22k in the first stage of the slot inside SI may come out to the area CE2a in the coil end portion CE2 corresponding to the first stage of the slot inside SI. Or, for example, the conductor wires 21 coming from the area CE2c in the coil end portion CE2 corresponding to the third stage of the slot inside SI may directly enter the position 22l or 22x in the third stage of the slot inside SI. Or, for example, the conductor wires 21 coming from the position 22y or 22m in the third stage of the slot inside SI may come out to the area CE1c in the coil end portion CE1 corresponding to the third stage of the slot inside SI.

Finally, winding the conductor wires 21 is terminated at the intermediate position (position 22z) between the two slots 9a and 9b. Thus, the coil 217 having different arrangement of the conductor wire 21 between the slot inside SI and each coil end portion CE1, CE2 can be formed.

The bending angles of the conductor wires 21 forming the coil 217 will be described with reference to FIG. 12.

For example, the bending angle θ″ in the arrangement changing portion 20a is an angle between an extending direction DR17c of the third conductor wire group 17c and an extending direction DR17f of the fourth conductor wire group 17f, which is an angle facing the inside of the coil 217. Since the coil 217 has a hexagonal shape in side view, the angle θ″, for example, satisfies the aforementioned Expression 2. The angle θ″ satisfying Expression 2 is, for example, 120°.

For example, the bending angle θ in the arrangement changing portion 20d is an angle between an extending direction DR17a of the first conductor wire group 17a and an extending direction DR17b of the second conductor wire group 17b, which is an angle facing the inside of the coil 217. The angle θ satisfies the aforementioned Expression 3. The angle θ satisfying Expression 3 is, for example, 120°.

For example, the bending angle θ′ in the passing area changing portion 23a is an angle between the extending direction DR17b of the second conductor wire group 17b and the extending direction DR17c of the third conductor wire group 17c, which is an angle facing the inside of the coil 217. The angle θ′ satisfies the aforementioned Expression 4.

For example, when the coil 217 has a symmetric shape as shown in FIG. 11 and FIG. 12, the aforementioned Expression 5 is established. When Expression 5 is substituted into Expression 4, the aforementioned Expression 6 is obtained.

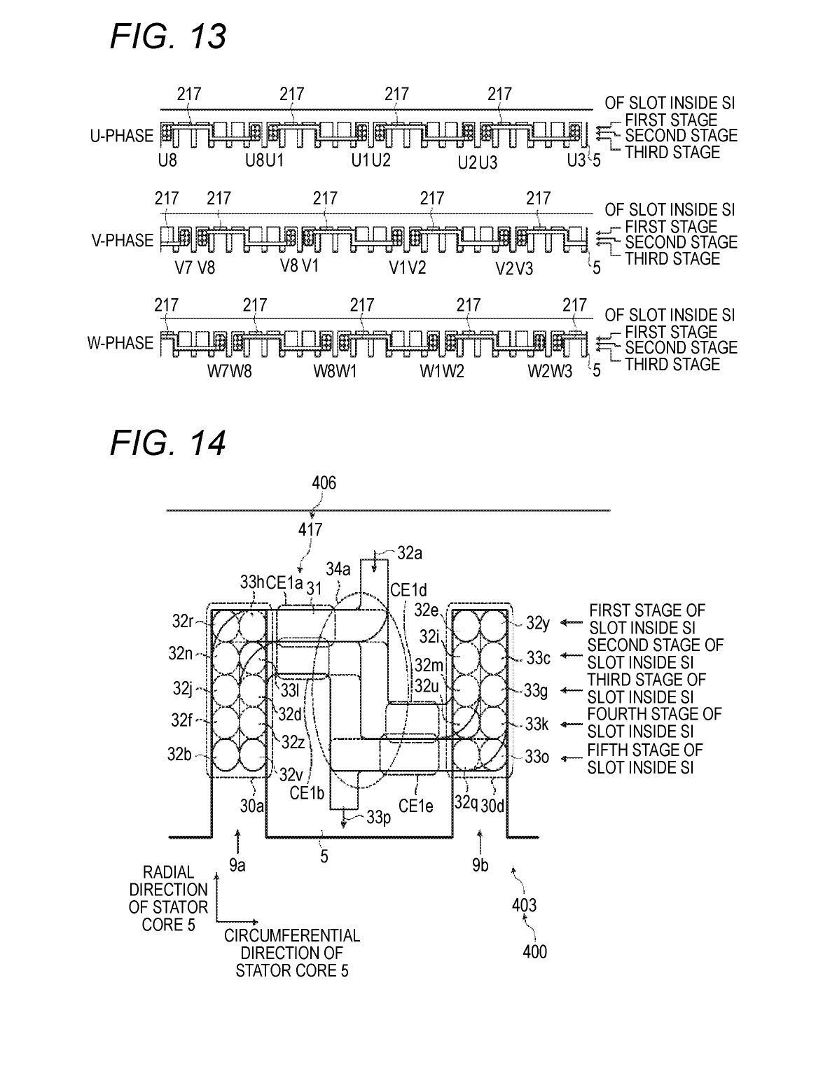

FIG. 13 shows a configuration view of windings for each phase in the stator in which coils have been inserted into the stator core in order to form stator windings of a rotary electrical machine. FIG. 13 shows a case in which a coil 217 of one and the same phase appear in every two slots when the number of slots in each pole and each phase is two (8 poles and 48 slots). Each coil 217 is wound so that windings of the coil 217 to be inserted into corresponding-phase slots 9 adjacent to each other can be put on top of each other and inserted into the slots 9 of the stator core 5 at an interval of 4 slots. Incidentally, the stator core 5 in FIG. 13 is illustrated as a straight line shape for the sake of easiness of explanation. In addition, halfway parts of the stator core 5 are not shown in FIG. 13.

For example, V-phase windings V8 have a coil 217 in which a coil 217 of U-phase windings U8 has been shifted circumferentially in the right direction of FIG. 13 by two slots. For example, W-phase windings W8 have a coil 217 in which the coil 217 of the V-phase windings V8 has been shifted circumferentially in the right direction of FIG. 13 by two slots. That is, when the coils 217 in FIG. 13 are observed at the right end, the arrangement pattern of the U-phase, V-phase and W-phase coils 217 distributed in two-slot pitches is repeated in a 6-slot cycle. Each coil 217 is mounted over 6 slots in the coil end portion so that the coil 217 can pass through an area of the first stage in the left three slots and pass through an area of the third stage in the right three slots.

In this manner, according to Embodiment 2, the arrangement of the conductor wires 21 having three stages in the radial direction in the slot inside SI is changed into one stage in the radial direction in each coil end portion CE1, CE2. For example, when the conductor wires 21 are formed in a crank shape in the middle of the coil end portion CE1, CE2, the conductor wires 21 in the left half of the coil end portion CE1 can be collected in the area CE1a (see FIG. 9) corresponding to the first stage of the slot inside SI, and the conductor wires 21 in the right half of the coil end portion CE1 can be collected in the area CE1c (see FIG. 9) corresponding to the third stage of the slot inside SI. As a result, when the coils 217 having similar shapes are used for windings of respective phases, windings of one phase can be prevented from interfering with windings of another phase easily in the coil end portion CE1, CE2, so that the height of the coil end portion CE1, CE2 can be reduced. That is, mechanical interference among the windings of the respective phases in the coil end portion CE1, CE2 can be reduced, and the winding length for each phase can be made uniform (for example, equal). As a result, when the conductor wires 21 are disposed radially in three stages in the slot inside SI, the outer diameter of the coil end portion can be reduced, and unbalance in winding resistance value among the phases can be suppressed within an allowable range.

### Embodiment 3

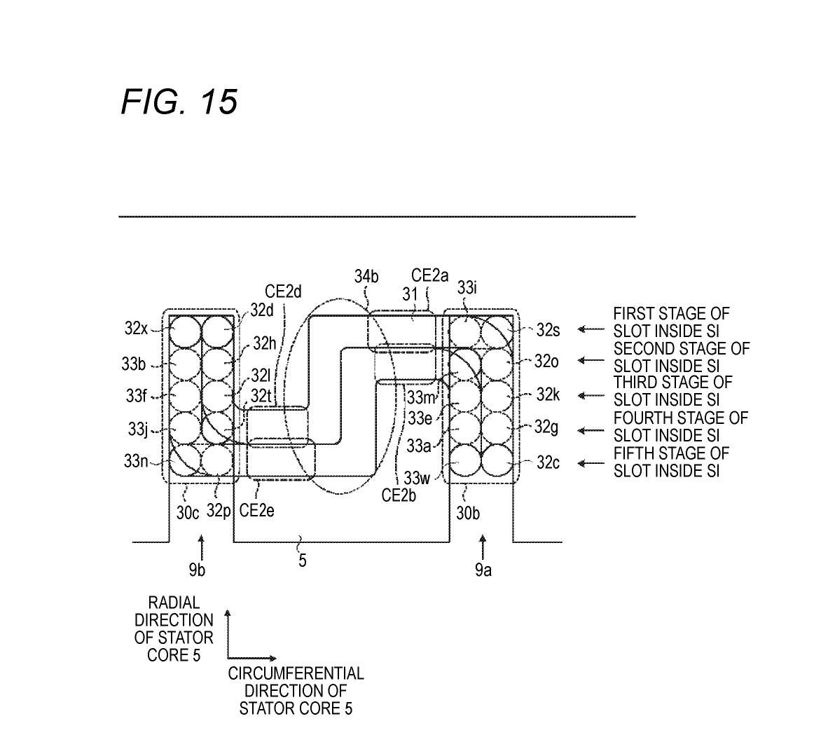

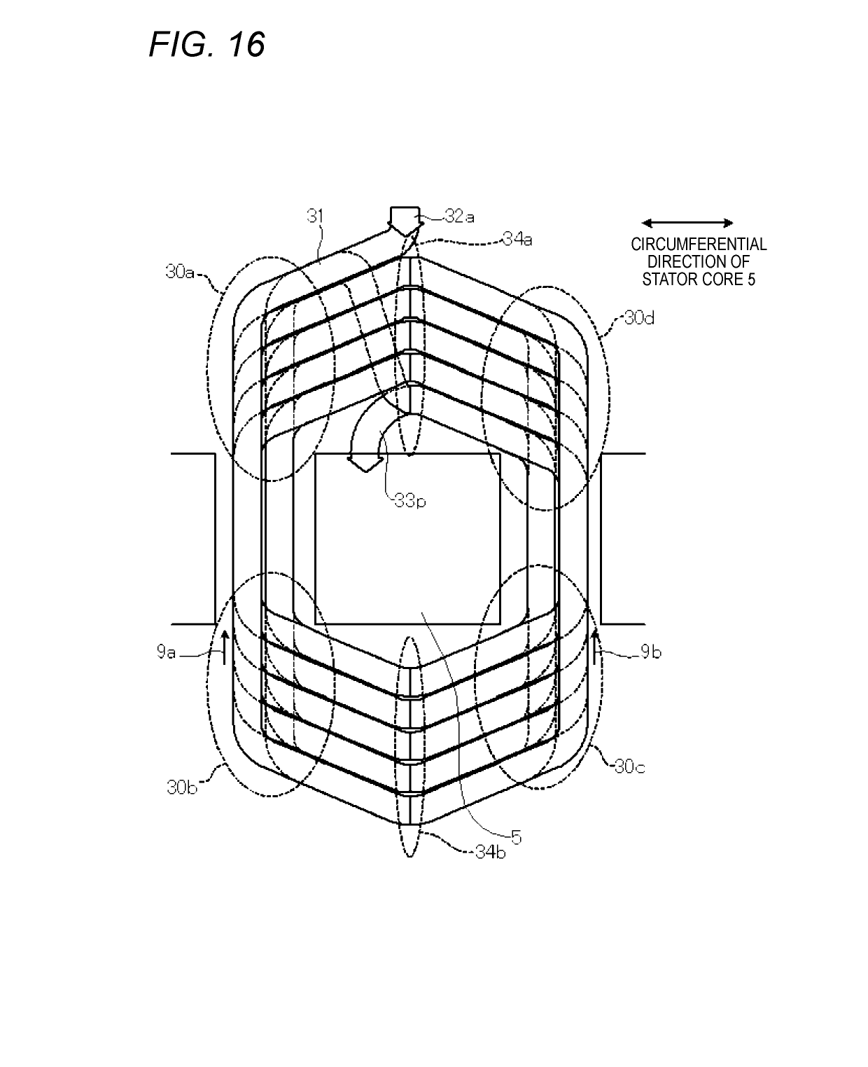

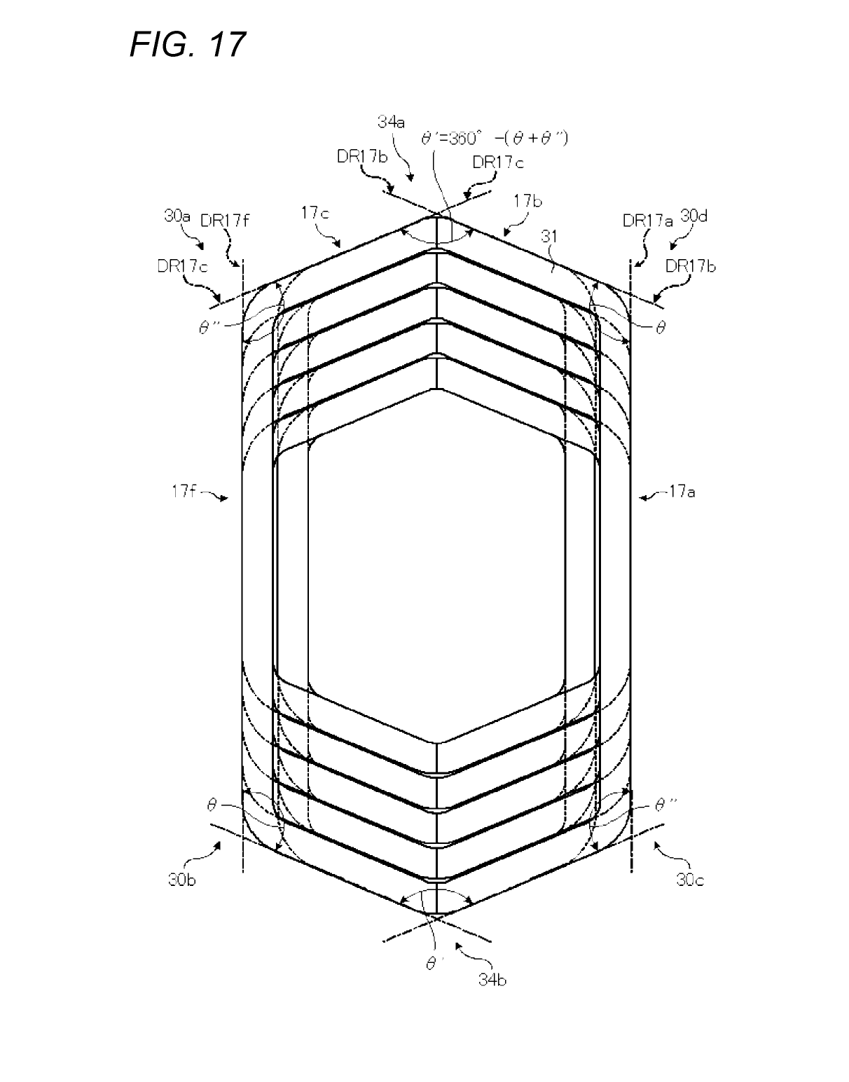

Next, a rotary electrical machine according to Embodiment 3 will be described. FIG. 14 is a view showing a state in which a coil has been inserted into a stator core, the state being observed from the top of the stator core. FIG. 15 is a view showing the state in which the coil has been inserted into the stator core, the state being observed from the bottom of the stator core. FIG. 16 is a view showing the state in which the coil has been inserted into the stator core, the state being observed from a side (surface facing a rotation axis RA) of the stator core. FIG. 17 is a view for explaining bending angles of a conductor wire forming the coil. The following description will be made mainly around different parts from Embodiment 1.

In Embodiment 1, exemplar description has been made about a coil in which the arrangement of the conductor wire having two stages in the radial direction in the slot inside SI is changed into one stage in the radial direction in each coil end portion CE1, CE2. In Embodiment 3, exemplar description will be made about a coil in which the arrangement of conductor wires having five stages in the radial direction in the slot inside SI is changed into two stages in the radial direction in each coil end portion CE1, CE2.

Specifically, in stator windings 406 of a stator 403 in a rotary electrical machine 400, the configuration of each coil 417 forming windings of each phase is different from that in Embodiment 1 at the following points as shown in FIG. 14 to FIG. 17.

FIG. 14 to FIG. 16 show a state in which one coil 417 measuring 5 stages (in the radial direction of the stator core 5) by two lines (in the circumferential direction of the stator core 5) in the slot inside SI has been inserted. How to wind conductor wires 31 to form the coil 417 on this occasion will be described using symbols from a position 32a to a position 32z and a position 33a to a position 33p by way of example.

In the coil 417, winding the conductor wire 31 is started at an intermediate position (position 32a) between two slots 9a and 9b. The conductor wire 31 passing through an area CE1a in the coil end portion CE1 (see FIG. 2) corresponding to the first stage of the slot inside SI approaches the slot 9a. After that, the arrangement of the conductor wire 31 is changed (in an arrangement changing portion 30a) so that the conductor 31 can enter a position 32b in the fifth stage of the slot inside SI. When this portion is observed from a side, the conductor wire is bent at an angle θ″ (see FIG. 16 and FIG. 17).

The conductor wire 31 passing through the slot inside SI comes out from a position 32c (see FIG. 15). Then the arrangement of the conductor wire 31 is changed (in an arrangement changing portion 30b) so that the conductor wire 31 can come out to an area CE2a in the coil end portion CE2 (see FIG. 2) corresponding to the first stage of the slot inside SI. When this portion is observed from a side, the conductor wire is bent at an angle θ (see FIG. 16 and FIG. 17).

The conductor wire 31 goes toward the slot 9b on the opposite side. When the conductor wire 31 reaches the intermediate position between the slot 9a and the slot 9b, the arrangement of the conductor wire 31 is changed (in a passing area changing portion 34b) so that the conductor wire 31 can pass through an area CE2d in the coil end portion CE2 (see FIG. 2) corresponding to the fourth stage of the slot inside SI this time. When this portion is observed from a side, the conductor wire is bent at an angle θ′ (see FIG. 16 and FIG. 17).

When the conductor wire 31 approaches the slot 9b, the arrangement of the conductor wire 31 is changed (in an arrangement changing portion 30c) so that the conductor wire 31 can enter a position 32d in the first stage of the slot inside SI. When this portion is observed from a side, the conductor wire 31 is bent at the angle θ″ (see FIG. 16 and FIG. 17).

The conductor wire 31 passing through the slot inside SI comes out from a position 32e (see FIG. 14). Then the arrangement of the conductor wire 31 is changed (in an arrangement changing portion 30d) so that the conductor wire 31 can come out to an area CE1d corresponding to the fourth stage of the slot inside SI. When this portion is observed from a side, the conductor wire 31 is bent at the angle θ (see FIG. 16 and FIG. 17).

The conductor wire 31 goes toward the slot 9a on the opposite side. When the conductor wire 31 reaches the intermediate position between the slot 9a and the slot 9b, the arrangement of the conductor wire 31 is changed (in a passing area changing portion 34a) so that the conductor wire 31 can pass through the area CE1a corresponding to the first stage of the slot inside SI again. When this portion is observed from a side, the conductor wire 31 is bent at the angle θ′ (see FIG. 16 and FIG. 17).

In this manner, the conductor wire 31 forming the coil 417 is wound by one turn. Subsequently in the same manner, the conductor wire 31 is wound in the order of a position 32f, a position 32g, a position 32h, . . . , a position 32t, and a position 32u. The conductor wire 31 in the coil end portion CE1, CE2 so far passes through the area CE1a, CE2a corresponding to the first stage of the slot inside SI and the area CE1d, CE2d corresponding to the fourth stage of the slot inside SI. In side view, five conductor wires are arranged side by side in the coil end portion CE1, CE2. The conductor wires 31 are disposed so that the conductor wire 31 wound in the third turn can be located on the inner side of the conductor wire 31 wound in the second turn as shown in FIG. 16.

In addition, the arrangement changing portions 30a to 30d change the arrangement of the conductor wires 31 entering and leaving the slot inside SI when the conductor wires 31 are wound in the first, second, third and fourth turns, but actually do not change the arrangement when the conductor wire 31 is wound in the fifth turn.

Further successively, the conductor wire 31 coming out from the position 32u (see FIG. 14) passes through the area CE1d corresponding to the fourth stage of the slot inside SI and goes toward the slot 9a on the opposite side. When the conductor wire 31 reaches the intermediate position between the slot 9a and the slot 9b, the arrangement of the conductor wire 31 is changed (in the passing area changing portion 34a) so that the conductor wire 31 can pass through the area CE1b corresponding to the second stage of the slot inside SI. When this portion is observed from a side, the conductor wire 31 is bent at the angle θ′ (see FIG. 16 and FIG. 17).

When the conductor wire 31 approaches the slot 9a, the arrangement of the conductor wire 31 is changed (in the arrangement changing portion 30a) so that the conductor wire 31 can enter a position 32v in the fifth stage of the slot inside SI. When this portion is observed from a side, the conductor wire 31 is bent at the angle θ″ (see FIG. 16 and FIG. 17).

The conductor wire 31 passing through the slot inside SI comes out from a position 32w (see FIG. 15). Then the arrangement of the conductor wire 31 is changed (in the arrangement changing portion 30b) so that the conductor wire 31 can come out to an area CE2b corresponding to the second stage of the slot inside SI. When this portion is observed from a side, the conductor wire 31 is bent at the angle θ (see FIG. 16 and FIG. 17).

The conductor wire 31 goes toward the slot 9b on the opposite side. When the conductor wire 31 reaches the intermediate position between the slot 9a and the slot 9b, the arrangement of the conductor wire 31 is changed (in the passing area changing portion 34b) so that the conductor wire 31 can pass through an area CE2e corresponding to the fifth stage of the slot inside SI this time. When this portion is observed from a side, the conductor wire 31 is bent at the angle θ′ (see FIG. 16 and FIG. 17).

When the conductor wire 31 approaches the slot 9b, the arrangement of the conductor wire 31 is changed (in the arrangement changing portion 30c) so that the conductor wire 31 can enter a position 32x in the first stage of the slot inside SI. When this portion is observed from a side, the conductor wire 31 is bent at the angle θ″ (see FIG. 16 and FIG. 17).

The conductor wire 31 passing through the slot inside SI comes out from a position 32y (see FIG. 14). Then the arrangement of the conductor wire 31 is changed (in the arrangement changing portion 30d) so that the conductor wire 31 can come out to an area CE1e corresponding to the fifth stage of the slot inside SI. When this portion is observed from a side, the conductor wire 31 is bent at the angle θ (see FIG. 16 and FIG. 17).

The conductor wire 31 goes toward the slot 9a on the opposite side. When the conductor wire 31 reaches the intermediate position between the slot 9a and the slot 9b, the arrangement of the conductor wire 31 is changed (in the passing area changing portion 34a) so that the conductor wire 31 can pass through the area CE1b corresponding to the second stage of the slot inside SI again. When this portion is observed from a side, the conductor wire 31 is bent at the angle θ′ (see FIG. 16 and FIG. 17).

In this manner, the conductor wire 31 forming the coil 417 is wound by one turn. Subsequently in the same manner, the conductor wire 31 is wound in the order of a position 32z, a position 33a, a position 33b, a position 33c, . . . , a position 33n, and a position 33o. The conductor wires 31 in the coil end portion CE1, CE2 so far passes through the area CE1b, CE2b corresponding to the second stage of the slot inside SI and the area CE1e, CE2e corresponding to the fifth stage of the slot inside SI. In side view, five conductor wires 31 are arranged side by side in the coil end portion. The conductor wires 31 are disposed so that the conductor wire 31 wound in the third turn can be located on the inner side of the conductor wire 31 wound in the second turn as shown in FIG. 16.

In addition, the arrangement changing portions 30a to 30d change the arrangement of the conductor wires 31 entering and leaving the slot inside when the conductor wires 31 are wound in the first, second, third and fourth turns, but actually do not change the arrangement when the conductor wire 31 is wound in the fifth turn.

The bending angles of the conductor wires 31 forming the coil 417 will be described with reference to FIG. 17.

For example, the bending angle θ″ in the arrangement changing portion 30a is an angle between an extending direction DR17c of the third conductor wire group 17c and an extending direction DR17f of the fourth conductor wire group 17f, which is an angle facing the inside of the coil 217. Since the coil 417 has a hexagonal shape in side view, the angle θ″, for example, satisfies the aforementioned Expression 2. The angle θ″ satisfying Expression 2 is, for example, 120°.

For example, the bending angle θ in the arrangement changing portion 30d is an angle between an extending direction DR17a of the first conductor wire group 17a and an extending direction DR17b of the second conductor wire group 17b, which is an angle facing the inside of the coil 417. The angle θ satisfies the aforementioned Expression 3. The angle θ satisfying Expression 3 is, for example, 120°.

For example, the bending angle θ′ in the passing area changing portion 34a is an angle between the extending direction DR17b of the second conductor wire group 17b and the extending direction DR17c of the third conductor wire group 17c, which is an angle facing the inside of the coil 417. The angle θ′ satisfies the aforementioned Expression 4.

For example, when the coil 417 has a symmetric shape as shown in FIG. 16 and FIG. 17, the aforementioned Expression 5 is established. When Expression 5 is substituted into Expression 4, the aforementioned Expression 6 is obtained.

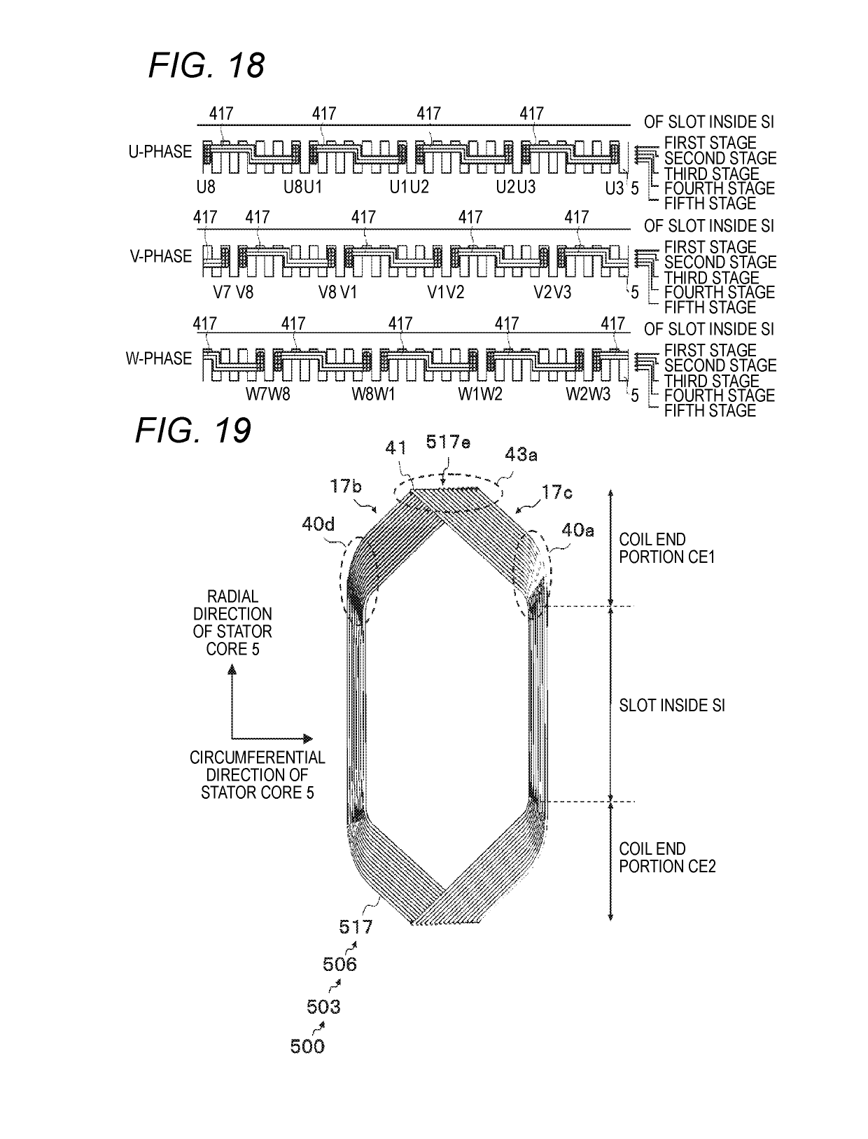

FIG. 18 shows a configuration view of windings for each phase in the stator in which coils have been inserted into the stator core in order to form stator windings of a rotary electrical machine. FIG. 18 shows a case in which a coil 417 of one and the same phase appears in every two slots when the number of slots in each pole and each phase is two (8 poles and 48 slots). Each coil 417 is wound so that windings of the coil 417 to be inserted into corresponding-phase adjacent to each other can be put on top of each other and inserted into the slots of the stator core 5 at an interval of 4 slots. Incidentally, the stator core 5 in FIG. 18 is illustrated as a straight line shape for the sake of easiness of explanation. In addition, halfway parts of the stator core 5 are not shown in FIG. 18.

For example, V-phase windings V8 have a coil 417 in which a coil 417 of U-phase windings U8 has been shifted circumferentially in the right direction of FIG. 18 by two slots. For example, W-phase windings W8 have a coil 417 in which the coil 417 of the V-phase windings V8 has been shifted circumferentially in the right direction of FIG. 18 by two slots. That is, when the coils 417 in FIG. 18 are observed at the right end, the arrangement pattern of the U-phase, V-phase and W-phase coils 417 distributed in two-slot pitches is repeated in a 6-slot cycle. Each coil 417 is mounted over 6 slots in the coil end portion so that the coil 417 can pass through an area of the first stage and the second stage in the left three slots and pass through an area of the fourth stage and the fifth stage in the right three slots.

In this manner, according to Embodiment 3, when the coil 417 is used, the conductor wires 31 in the left half of each coil end portion CE1, CE2 can be collected in the area CE1a and CE1b, the areas CE2a and CE2b (see FIG. 14 and FIG. 15) corresponding to the first stage and the second stage of the slot inside SI, and the conductor wires 31 in the right half of the coil end portion CE1, CE2 can be collected in the areas CE1d and CE1e, the areas CE2d and CE2e corresponding to the fourth stage and the fifth stage of the slot inside SI. As a result, the U-phase, V-phase and W-phase windings can be prevented from interfering with one another easily. Although there appears in FIG. 18 an area where the coils 417 inserted into the U-phase, the V-phase and the W-phase overlap one another, each coil 417 in each coil end portion CE1, CE2 is formed in a triangle in fact. The center (a part like a crank shape in each passing area changing portion) of the coil 417 is an apex of the triangle. Thus, the U-phase, V-phase and W-phase windings can be prevented from interfering with one another easily. In this manner, the height of the coil end portion can be reduced so that the stator windings using the coils 417 whose circumferential lengths are short can be formed.

That is, the arrangement of the conductor wires 31 is changed between the slot inside SI and each coil end portion CE1, CE2, (the arrangement changing portion 30a to 30d) and the arrangement of the conductor wire 31 is changed in the radial direction of the stator core 5 in the coil end portion CE1, CE2 (in the passing area changing portion 34a, 34b). Thus, windings of one phase can be prevented from interfering with windings of another phase easily in the coil end portion CE1, CE2, so that the height of the coil end portion CE1, CE2 can be reduced.

In addition, according to Embodiment 3, coils having the same shape may be used for all the U phase, the V phase and the W phase. Thus, the efficiency in the work of forming windings can be improved, and the winding length for each phase can be made equal. Therefore, unbalance in winding resistance value among the phases can be suppressed within an allowable range. It is therefore possible to reduce torque ripples or vibration etc.

### Embodiment 4

Next, a rotary electrical machine according to Embodiment 4 will be described. FIG. 19 is a configuration view of a coil forming stator windings. The following description will be made mainly around different parts from Embodiments 1 to 3.

In Embodiments 1 to 3, description has been made about, of coils whose arrangements are changed between the slot inside and each coil end portion, a coil having a triangular shape as its coil shape in the coil end portion. In Embodiment 4, description will be made about a method in which a passing area changing portion is disposed to be displaced by a distance X with respect to the circumferential direction of a stator core each time a conductor wire is wound by one turn in the coil end portion, so that the apex of a triangular shape of the coil end portion can be displaced by the distance X each time the conductor wire is wound by one turn. The distance X will be described later.

Specifically, in stator windings 506 of a stator 503 in a rotary electrical machine 500, a coil 517 forming windings of each phase has, for example, a configuration shown in FIG. 19.

The coil 517 is wound and inserted into slots of a stator core 5 so that windings of the coil 517 to be inserted into corresponding-phase slots adjacent to each other can be put on top of each other. The coil 517 is formed as a bundle of conductor wires 41.

Specifically, the coil 517 has a second bent portion 517e in place of the second bent portion 17e (see FIG. 2) as shown in FIG. 19.

In the second bent portion 517e, each conductor wire 41 is disposed to be displaced by the distance X in the circumferential direction of the stator core 5 each time the conductor wire 41 is wound by one turn. That is, a passing area changing portion 43a including the second bent portion 517e changes the arrangement from the arrangement (radially passing area) of the second conductor wire group 17b in the coil end portion CE1 to the arrangement (radially passing area) of the third conductor wire group 17c in the coil end portion CE1 while being displaced by the distance X in the circumferential direction of the stator core 5 each time the conductor wire 41 is wound by one turn. For example, assume that the angle θ and the angle θ″ are equal to each other, and the width of the conductor wire is W. In this case, when the aforementioned Expression 5 is established, the distance X can be obtained by the following Expression 7.

X=W/(−cos θ) Expression 7

For example, in FIG. 19, the coil 517 is formed out of the conductor wires 41 measuring two stages (in the radial direction of the stator core 5) by eight lines (in the circumferential direction of the stator core 5) in a slot inside SI. For example, the number of windings in the radial direction and the number of windings in the circumferential direction can be defined as follows.

For example, in the case shown in FIG. 19, the coil 517 changes the arrangement of windings (in an arrangement changing portion 40d) between the slot inside SI and a coil end portion CE1. Thus, the bundle of the conductor wires 41 measuring two stages (in the radial direction of the stator core 5) by eight lines (in the circumferential direction of the stator core 5) in the slot inside SI is arranged into windings measuring one stage (in the radial direction of the stator core 5) by sixteen lines (in the circumferential direction of the stator core 5) in the coil end CE1. In addition, on this occasion, the windings are bent at the angle θ (for example, 135° in FIG. 19).

Next, in the coil end portion CE1, the arrangement of the conductor wire 41 that is, for example, arranged in the first stage in the radial direction of the stator core 5 is changed to, for example, the second stage in the radial direction of the stator core 5 (in the passing area changing portion 43a including the second bent portion 517e) to avoid interference with windings of another phase (the coil 517 of another phase). Also on this occasion, between before and after changing the arrangement, that is, in the second bent portion 517e, the conductor wire 41 is bent at the angle θ′ (for example, 90° in FIG. 19).

After that, when coming back from the coil end portion CE1 to the slot inside SI again, the arrangement of windings is changed (in the arrangement changing portion 40a). Thus, the bundle of the conductor wires 41 measuring one stage (in the radial direction of the stator core 5) by sixteen lines (in the circumferential direction of the stator core 5) in the coil end portion CE1 is arranged to windings measuring two stages (in the radial direction of the stator core 5) by eight lines (in the circumferential direction of the stator core 5) in the slot inside SI. In addition, on this occasion, the conductor wire 41 is bent at the angle θ″ (for example, 135° in FIG. 19).

When the coil 517 is configured thus, the coil shape in the coil end portion CE1 is formed in a triangle. In addition, though not explained, the arrangement of the conductor wire 41 is also changed in the lower half of the coil 517 in the same manner. As a whole, the coil 517 has a hexagonal shape.

Incidentally, FIG. 19 showing this embodiment is different from FIG. 2 showing Embodiment 1 described previously, at the point that a conductor wire passing area changing portion 49 is disposed to be displaced by the distance X in the circumferential direction of the stator core in the coil end portion each time the conductor wire is wound by one turn. In this manner, the apex of the triangular shape in the coil end portion can be displaced by the distance X each time the conductor wire is wound by one turn. Thus, the height of the coil end portion can be made further lower than that in FIG. 2 in which the position of the apex is fixed in the circumferential direction.

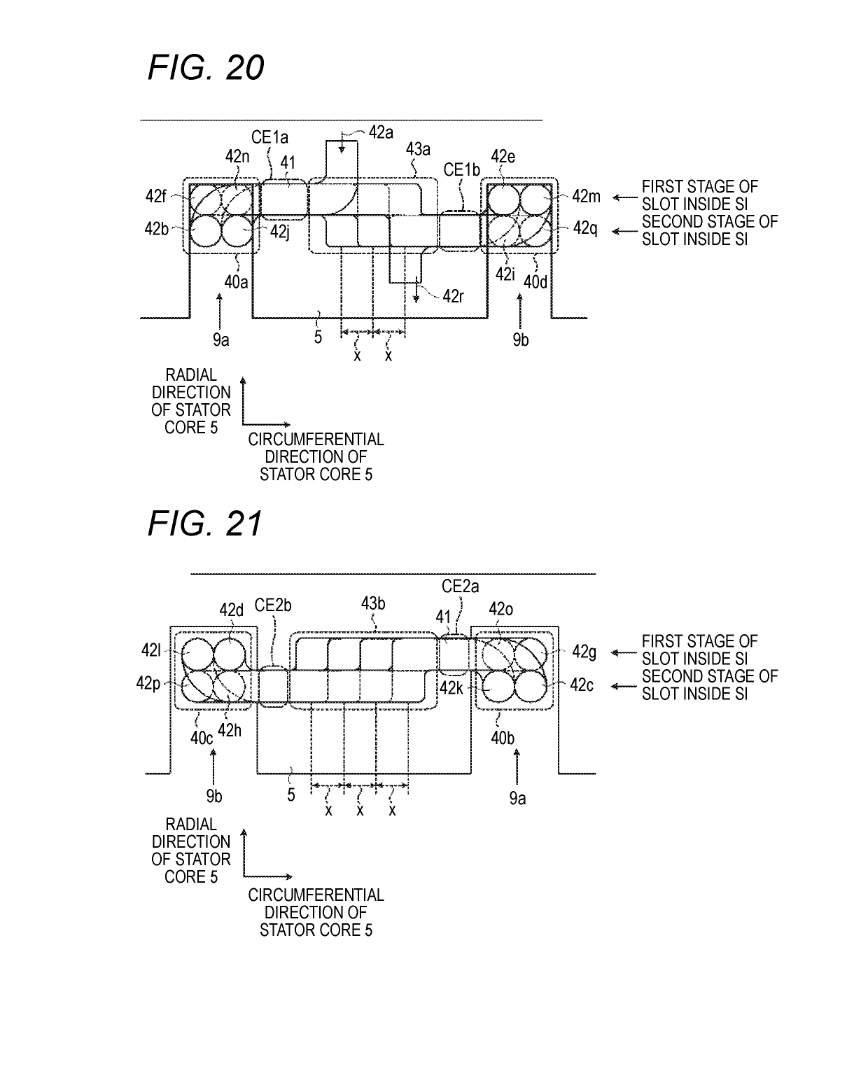

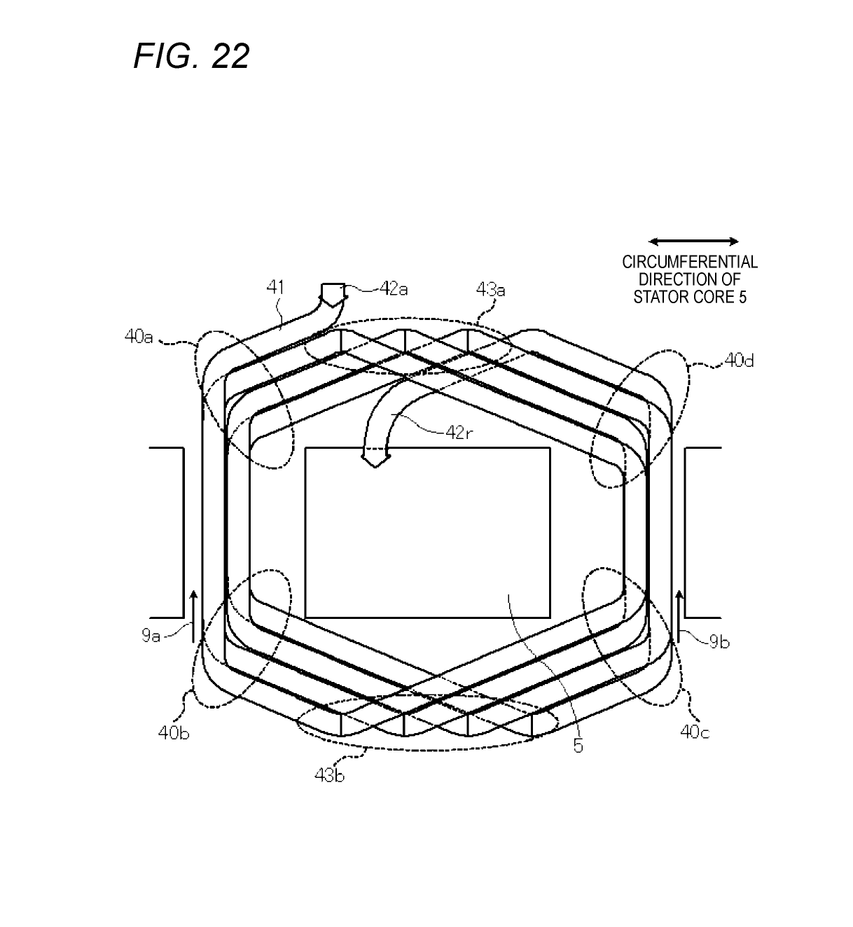

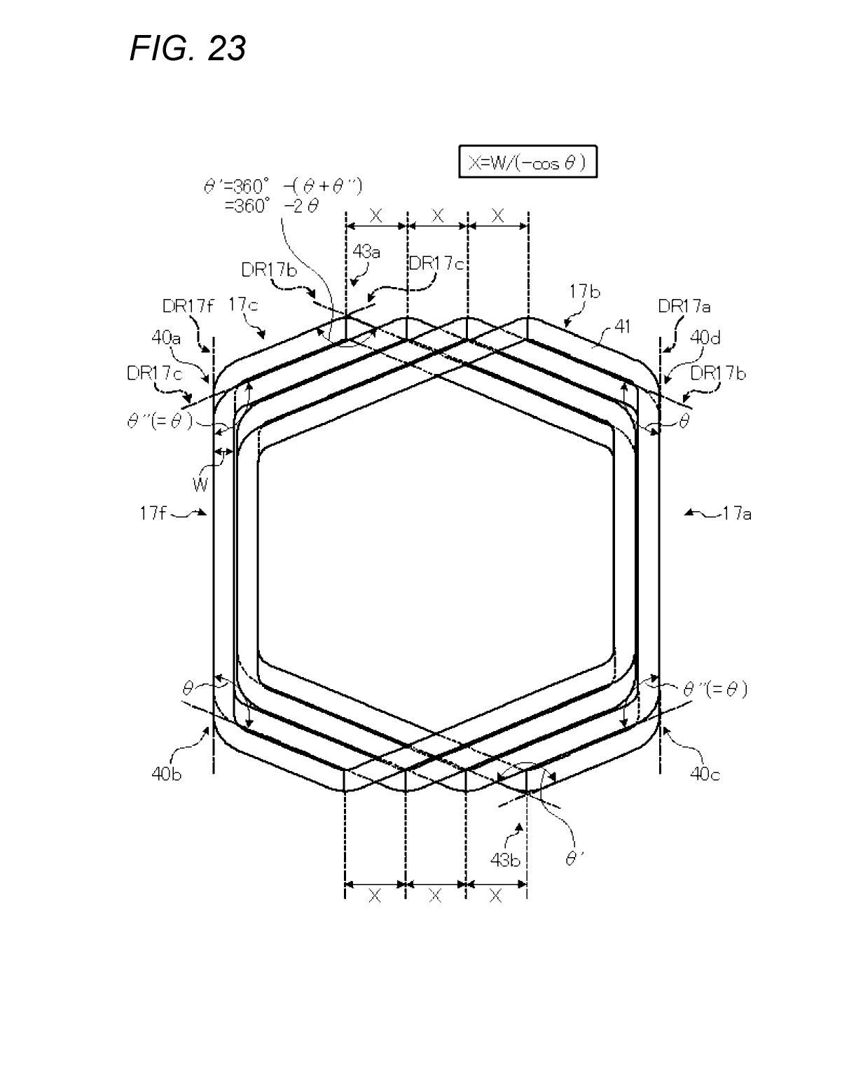

FIG. 20 is a view showing a state in which a coil has been inserted into a stator core, the state being observed from the top of the stator core. FIG. 21 is a view showing the state in which the coil has been inserted into the stator core, the state being observed from the bottom of the stator core. FIG. 22 is a view showing the state in which the coil has been inserted into the stator core, the state being observed from a side (surface facing a rotation axis RA) of the stator core. FIG. 23 is a view for explaining bending angles and dimensions of a conductor wire forming the coil. The parts where the arrangement of windings in the coil 517 is changed will be described more in detail with reference to FIG. 20 to FIG. 23.

FIG. 20 to FIG. 22 show a state in which the coil 517 measuring two stages (in the radial direction of the stator core 5) by two lines (in the circumferential direction of the stator core 5) in the slot inside SI has been inserted. How to wind the conductor wire to form the coil 517 on this occasion will be described using a position 42a to a position 42r by way of example.

In the coil 517, winding the conductor wire 41 is started at an intermediate position (position 42a) between two slots 9a and 9b. The conductor wire 41 passing through an area CE1a corresponding to the first stage of the slot inside SI approaches the slot 9a. After that, the arrangement of the conductor wire 41 is changed (in the arrangement changing portion 40a) so that the conductor wire 41 can enter a position 42b in the second stage of the slot inside SI. When this portion is observed from a side, the conductor wire 41 is bent at the angle θ″ (see FIG. 22 and FIG. 23).

The conductor wire 41 passing through the slot inside SI comes out from a position 42c (see FIG. 21). Then the arrangement of the conductor wire 41 is changed (in an arrangement changing portion 40b) so that the conductor wire 41 can come out to an area CE2a corresponding to the first stage of the slot inside SI. When this portion is observed from a side, the conductor wire 41 is bent at the angle θ (see FIG. 22 and FIG. 23).

The conductor wire 41 goes toward the slot 9b on the opposite side. When the conductor wire 41 reaches the intermediate position between the slot 9a and the slot 9b, the arrangement of the conductor wire 41 is changed (in a passing area changing portion 43b) so that the conductor wire 41 can pass through an area CE2b corresponding to the second stage of the slot inside SI this time. When this portion is observed from a side, the conductor wire 41 is bent at the angle θ′ (see FIG. 22 and FIG. 23).

When the conductor wire 41 approaches the slot 9b, the arrangement of the conductor wire 41 is changed (in an arrangement changing portion 40c) so that the conductor wire 41 can enter a position 42d in the first stage of the slot inside SI. When this portion is observed from a side, the conductor wire 41 is bent at the angle θ″ (see FIG. 22 and FIG. 23).

The conductor wire 41 passing through the slot inside SI comes out from a position 42e (see FIG. 20). Then the arrangement of the conductor wire 41 is changed (in the arrangement changing portion 40d) so that the conductor wire 41 can come out to an area CE1d corresponding to the second stage of the slot inside SI. When this portion is observed from a side, the conductor wire 41 is bent at the angle θ (see FIG. 22 and FIG. 23).

The conductor wire 41 goes toward the slot 9a on the opposite side. When the conductor wire 41 reaches the intermediate position between the slot 9a and the slot 9b, the arrangement of the conductor wire 41 is changed (in the passing area changing portion 43a) so that the conductor wire 41 can pass through an area corresponding to the first stage of the slot inside again. When this portion is observed from a side, the conductor wire is bent at a predetermined angle.

In this manner, the conductor wire 41 forming the coil is wound by one turn. Subsequently in the same manner, the conductor wire 41 is wound in the order of a position 42f, a position 42g, a position 42h, . . . , a position 42p, and a position 42q. However, in the second and following turns of the conductor wire 41, the position of each passing area changing portion 43a, 43b is disposed to be displaced by the distance X in the circumferential direction of the stator core 5 each time the conductor wire 41 is wound by one turn. The passing area changing portion 43a, 43b is an apex of the triangular shape in the coil end portion CE1, CE2 in side view. To say other words, the apex of the conductor wire 41 in the coil end portion CE1, CE2 having a triangular shape is disposed to be displaced by the distance X in the circumferential direction of the stator core 5 each time the conductor wire 41 is wound by one turn.

Incidentally, in side view, for example, four conductor wires 41 are arranged side by side in the coil end portion CE1, CE2. As shown in FIG. 22, the first winding of the conductor wire 41 is disposed to be always located on the leftmost side of the four, and the other windings are disposed sequentially so that the third winding can be located adjacently to the second winding and on the right side thereof (the way of winding is different from that in FIG. 6 described in Embodiment 1).

In addition, the arrangement changing portions 40a to 40d change the arrangement of the conductor wire entering and leaving the slot inside when the conductor wire is wound in the first and third turns, but actually do not change the arrangement when the conductor wire is wound in the second or fourth turn.

Finally, in the coil 517, winding of the conductor wire 41 is ended at the intermediate position between the two slots 9a and 9b (in the position 42r).

The bending angles and dimensions of the conductor wire forming the coil will be described with reference to FIG. 23.

For example, the bending angle θ″ in the arrangement changing portion 40a is an angle between an extending direction DR17c of the third conductor wire group 17c and an extending direction DR17f of the fourth conductor wire group 17f, which is an angle facing the inside of the coil 517. Since the coil 517 has a hexagonal shape in side view, the angle θ″, for example, satisfies the aforementioned Expression 2. The angle θ″ satisfying Expression 2 is, for example, 135°.

For example, the bending angle θ in the arrangement changing portion 40d is an angle between an extending direction DR17a of the first conductor wire group 17a and an extending direction DR17b of the second conductor wire group 17b, which is an angle facing the inside of the coil 517. The angle θ satisfies the aforementioned Expression 3. The angle θ satisfying Expression 3 is, for example, 135°.

For example, the bending angle θ′ in the passing area changing portion 43a is an angle between the extending direction DR17b of the second conductor wire group 17b and the extending direction DR17c of the third conductor wire group 17c, which is an angle facing the inside of the coil 517. The angle θ′ satisfies the aforementioned Expression 4.

For example, when the coil 517 has a symmetric shape as shown in FIG. 22 and FIG. 23, the aforementioned Expression 5 is established. When Expression 5 is substituted into Expression 4, the aforementioned Expression 6 is obtained.

In addition, the position of the passing area changing portion 43a is disposed to be displaced by the distance X in the circumferential direction of the stator core 5 each time the conductor wire 41 is wound by one turn. The distance X is provided by the aforementioned Expression 7 when the width of the conductor wire is W, and the bending angle in the arrangement changing portion is θ (in the case where the aforementioned Expression 5 is established).

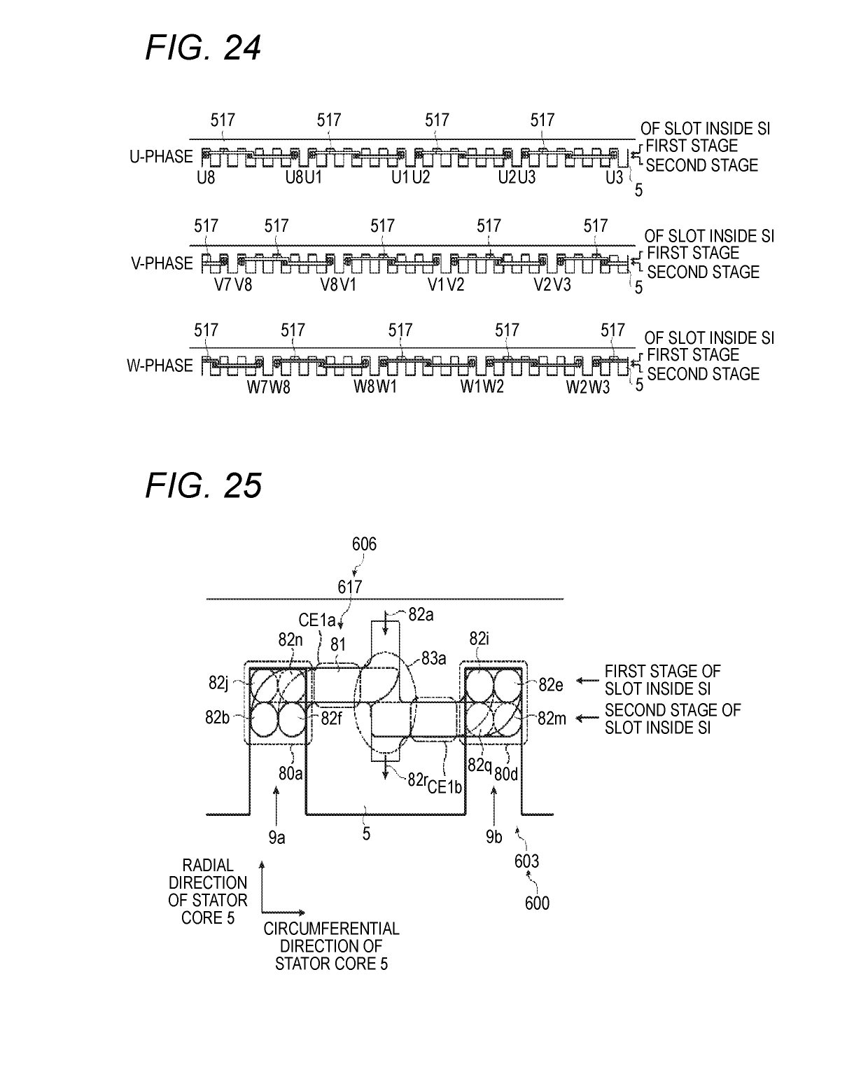

FIG. 24 shows a configuration view of windings for each phase in the stator in which coils have been inserted into the stator core in order to form stator windings of a rotary electrical machine. FIG. 24 shows a case in which a coil 517 of one and the same phase appears in every two slots when the number of slots in each pole and each phase is two (8 poles and 48 slots). Each coil 517 is wound so that windings of the coil 517 to be inserted into corresponding-phase slots adjacent to each other can be put on top of each other and inserted into the slots of the stator core 5 at an interval of 4 slots. Incidentally, the stator core 5 in FIG. 24 is illustrated as a straight line shape for the sake of easiness of explanation. In addition, halfway parts of the stator core 5 are not shown in FIG. 24.

For example, V-phase windings V8 have a coil 517 in which a coil 517 of U-phase windings U8 has been shifted circumferentially in the right direction of FIG. 24 by two slots. For example, W-phase windings W8 have a coil 517 in which the coil 517 of the V-phase windings V8 has been shifted circumferentially in the right direction of FIG. 24 by two slots. That is, when the coils 517 in FIG. 24 are observed at the right end, the arrangement pattern of the U-phase, V-phase and W-phase coils 517 distributed in two-slot pitches is repeated in a 6-slot cycle. Each coil 517 is mounted over 6 slots in the coil end portion so that the coil 517 can pass through an area of the first stage in the left three slots and pass through an area of the second stage in the right three slots.

In this manner, according to Embodiment 4, the passing area changing portion 43a for changing the arrangement of the conductor wire 41 in the radial direction of the stator core 5 in the coil end portion CE1, CE2 is disposed to be displaced by the distance X in the circumferential direction of the stator core 5 each time the conductor wire 41 is wound by one turn. Specifically, the passing area changing portion of the conductor wire 41 is disposed to be displaced by the distance X obtained by the aforementioned Expression 7 when the width of the conductor wire is W, and the bending angle in the arrangement changing portion is θ (in the case where the aforementioned Expression 5 is established) (see FIG. 20 and FIG. 21). Thus, the height of the coil 517 in the coil end portion CE1, CE2 can be made further lower.

### Embodiment 5

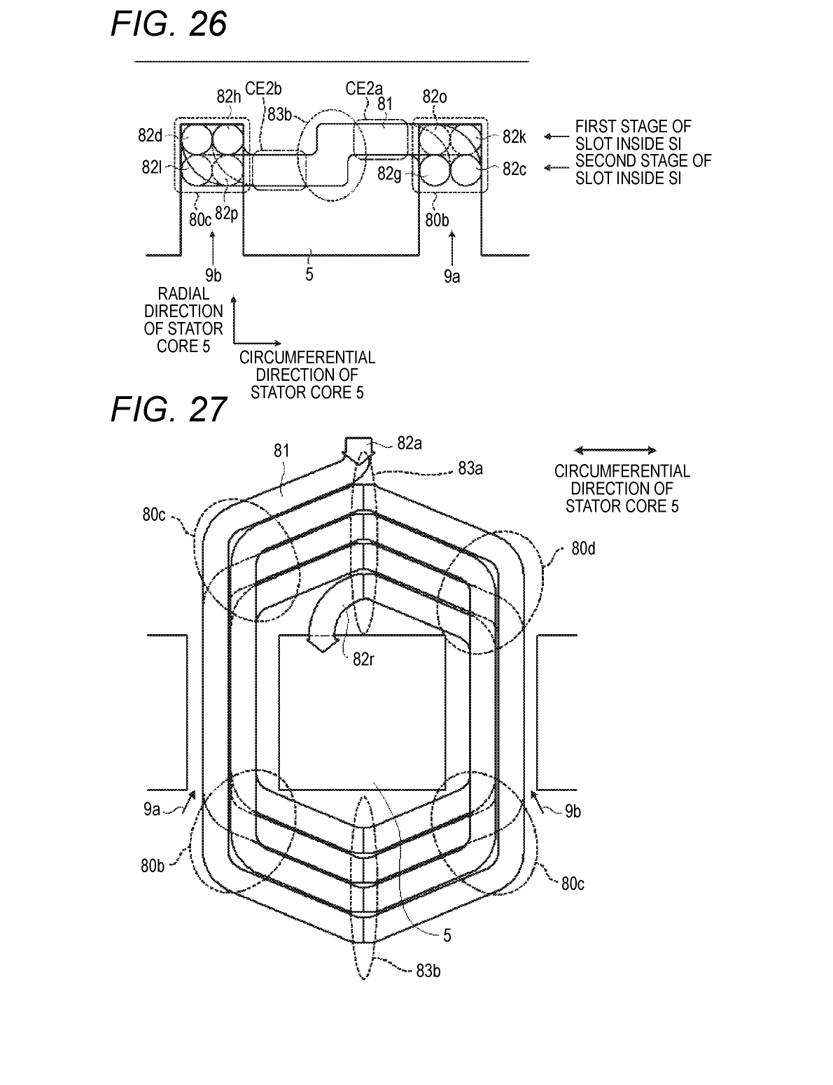

Next, a rotary electrical machine according to Embodiment 5 will be described. FIG. 25 is a view showing a state in which a coil has been inserted into a stator core, the state being observed from the top of the stator core. FIG. 26 is a view showing the state in which the coil has been inserted into the stator core, the state being observed from the bottom of the stator core. FIG. 27 is a view showing the state in which the coil has been inserted into the stator core, the state being observed from a side (surface facing a rotation axis RA) of the stator core. The following description will be made mainly around different parts from Embodiments 1 to 4.

The method described in Embodiments 1 to 4 is a case for attaining a coil in which the arrangement of a conductor wire differs between a slot inside and each coil end portion. However, the coil does not have to be formed in the procedure of the method.

In Embodiment 5, therefore, a procedure of forming a coil different from what has been described above will be described by way of example.

Specifically, in stator windings 606 of a stator 603 in a rotary electrical machine 600, a coil 617 forming windings of each phase has a configuration as shown in FIG. 25 to FIG. 27. The configuration is different from Embodiments 1 to 4 at the following point.

FIG. 25 to FIG. 27 show a state in which one coil 617 measuring two stages (in the radial direction of the stator core 5) by two lines (in the circumferential direction of the stator core 5) in the slot inside SI has been inserted. How to wind a conductor wire to form the coil 617 on this occasion will be described using a position 82a to a position 82r by way of example.

In the coil 617, winding a conductor wire 81 is started at an intermediate position (position 82a) between two slots 9a and 9b. The conductor wire 81 passing through an area CE1a corresponding to the first stage of the slot inside SI approaches the slot 9a. After that, the arrangement of the conductor wire 81 is changed (in an arrangement changing portion 80a) so that the conductor 81 can enter a position 82b in the second stage of the slot inside SI. When this portion is observed from a side, the conductor wire 81 is bent at an angle θ″ (see FIG. 27).

The conductor wire 81 passing through the slot inside SI comes out from a position 82c (see FIG. 26). Then the arrangement of the conductor wire 81 is changed (in an arrangement changing portion 80b) so that the conductor wire 81 can come out to an area CE2a corresponding to the first stage of the slot inside SI. When this portion is observed from a side, the conductor wire 81 is bent at an angle θ (see FIG. 27).

The conductor wire 81 goes toward the slot 9b on the opposite side. When the conductor wire 81 reaches the intermediate position between the slot 9a and the slot 9b, the arrangement of the conductor wire 81 is changed (in a passing area changing portion 83b) so that the conductor wire 81 can pass through an area CE2b corresponding to the second stage of the slot inside SI this time. When this portion is observed from a side, the conductor wire 81 is bent at an angle θ′ (see FIG. 27).

When the conductor wire 81 approaches the slot 9b, the arrangement of the conductor wire 81 is changed (in an arrangement changing portion 80c) so that the conductor wire 81 can enter a position 82d in the first stage of the slot inside SI. When this portion is observed from a side, the conductor wire 81 is bent at the angle θ″ (see FIG. 27).

The conductor wire 81 passing through the slot inside SI comes out from a position 82e (see FIG. 25). Then the arrangement of the conductor wire 81 is changed (in an arrangement changing portion 80d) so that the conductor wire 81 can come out to an area CE1b corresponding to the second stage of the slot inside SI. When this portion is observed from a side, the conductor wire 81 is bent at the angle θ (see FIG. 27).

The conductor wire 81 goes toward the slot 9a on the opposite side. When the conductor wire 81 reaches the intermediate position between the slot 9a and the slot 9b, the arrangement of the conductor wire 81 is changed (in a passing area changing portion 83a) so that the conductor wire 81 can pass through the area CE1a corresponding to the first stage of the slot inside SI again. When this portion is observed from a side, the conductor wire 81 is bent at the angle θ′ (see FIG. 27).

In this manner, the conductor wire 81 forming the coil 617 is wound by one turn. Subsequently in the same manner, the conductor wire 81 is wound in the order of a position 82f, a position 82g, a position 82h, . . . , a position 82p, and a position 82q. In side view, four conductor wires 81 are arranged side by side in the coil end portion CE1, CE2. The conductor wires 81 are disposed so that the conductor wire 81 wound in the third turn can be located on the inner side of the conductor wire 81 wound in the second turn as shown in FIG. 27.

In the procedure of forming the coil according to Embodiment 1, the arrangement changing portions 10a to 10d change the arrangement of the conductor wires entering and leaving the slot inside SI when the conductor wires are wound in the first and third turns, but actually do not change the arrangement when the conductor wires 11 are wound in the second or fourth turn (see FIGS. 4 to 6).

On the other hand, in the procedure of forming the coil 617 according to Embodiment 5, the arrangement changing portions 80a to 80d change the arrangement of the conductor wires entering and leaving the slot inside when the conductor wires are wound in the first and second turns, but actually do not change the arrangement when the conductor wires are wound in the third or fourth turn (for example, the conductor wire coming from an area corresponding to the first stage of the slot inside enters the first stage of the slot inside directly). In this embodiment, turns of the conductor wire 81 in which the arrangement of the conductor wire 81 is actually changed and turns of the conductor wire 81 in which the arrangement of the conductor wire 81 is not actually changed are successive. Therefore, bending (crank shape with right angles) for changing the arrangement is so uniform that the arrangement changing portions in the coil end portion can be made more compact.

In this manner, according to Embodiment 5, turns of the conductor wire in which the arrangement of the conductor wire is actually changed or turns of the conductor wire in which the arrangement of the conductor wire 81 is not actually changed are made successive. Therefore, bending (crank shape with right angles) for changing the arrangement is so uniform that the arrangement changing portions in the coil end portion can be made more compact.

Incidentally, Embodiment 5 has been described in contrast to Embodiment 1. However, the same technique can be also applied to Embodiments 2 to 4. In addition, the technique of Embodiment 5 can be also applied to Embodiment 6 that will be described below.

### Embodiment 6

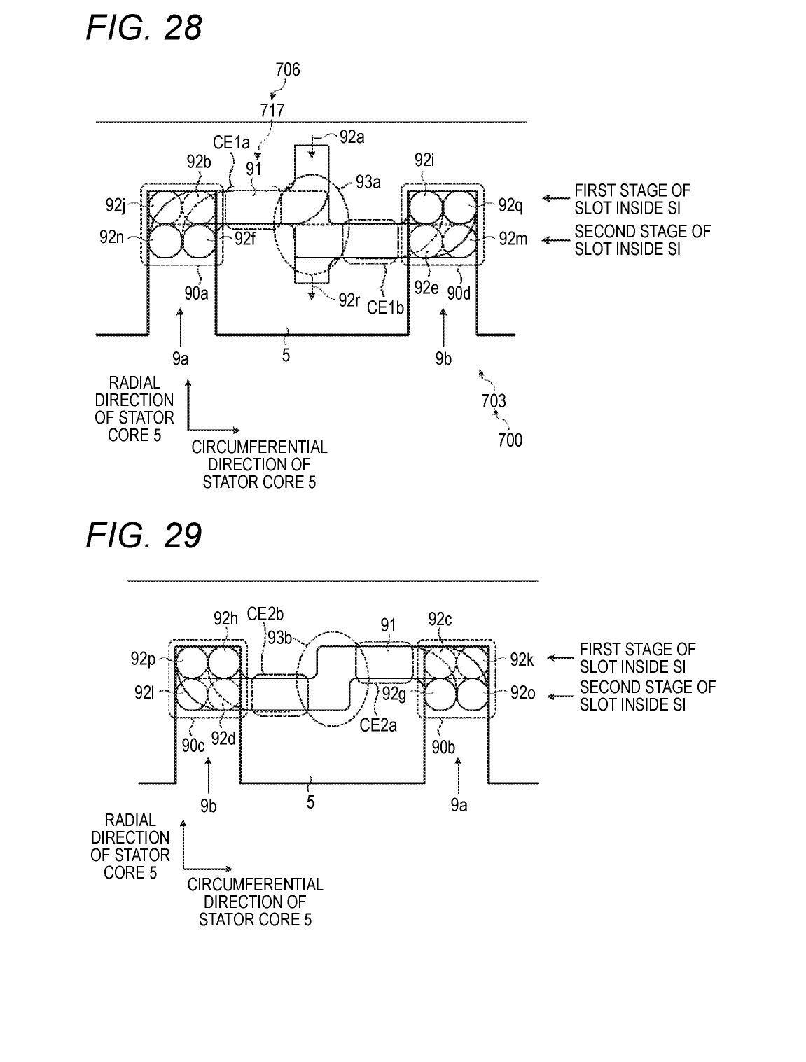

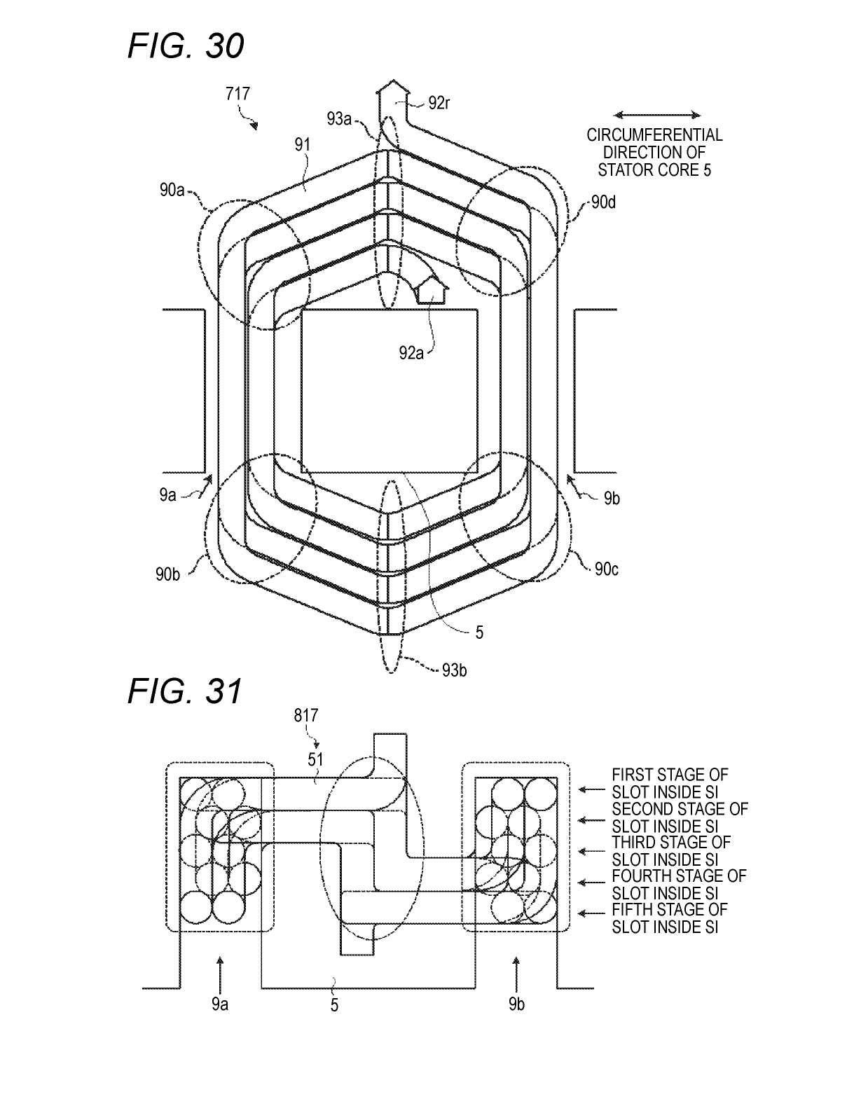

Next, a rotary electrical machine according to Embodiment 6 will be described. FIG. 28 is a view showing a state in which a coil has been inserted into a stator core, the state being observed from the top of the stator core. FIG. 29 is a view showing the state in which the coil has been inserted into the stator core, the state being observed from the bottom of the stator core. FIG. 30 is a view showing the state in which the coil has been inserted into the stator core, the state being observed from a side of the stator core. The following description will be made mainly around different parts from Embodiments 1 to 5.

The method described in Embodiments 1 to 5 is a case for attaining a coil in which the arrangement of a conductor wire differs between a slot inside and each coil end portion. However, the coil does not have to be formed in the procedure of the method.

In Embodiment 6, therefore, a procedure of forming a coil different from what has been described in Embodiments 1 to 5 will be described by way of example.

Specifically, in stator windings 706 of a stator 703 in a rotary electrical machine 700, a coil 717 forming windings of each phase has a configuration as shown in FIG. 28 to FIG. 30. The configuration is different from Embodiment 1 at the following point.

FIG. 28 to FIG. 30 show a state in which one coil 717 measuring two stages (in the radial direction of the stator core 5) by two lines (in the circumferential direction of the stator core 5) in the slot inside SI has been inserted. How to wind a conductor wire to form the coil 717 on this occasion will be described using a position 92a to a position 92r by way of example.

In the coil 717, winding a conductor wire 91 is started at an intermediate position (position 92a) between two slots 9a and 9b. The conductor wire 91 passing through an area CE1a corresponding to the first stage of the slot inside SI approaches the slot 9a. After that, the arrangement of the conductor wire 91 is changed (in an arrangement changing portion 90a) so that the conductor 91 can enter a position 92b in the second stage of the slot inside SI. When this portion is observed from a side, the conductor wire 91 is bent at an angle θ″ (see FIG. 30).

The conductor wire 91 passing through the slot inside SI comes out from a position 92c (see FIG. 29). Then the arrangement of the conductor wire 91 is changed (in an arrangement changing portion 90b) so that the conductor wire 91 can come out to an area CE2a corresponding to the first stage of the slot inside SI. When this portion is observed from a side, the conductor wire 91 is bent at an angle θ (see FIG. 30).

The conductor wire 91 goes toward the slot 9b on the opposite side. When the conductor wire 91 reaches the intermediate position between the slot 9a and the slot 9b, the arrangement of the conductor wire 91 is changed (in a passing area changing portion 93b) so that the conductor wire 91 can pass through an area CE2b corresponding to the second stage of the slot inside SI this time. When this portion is observed from a side, the conductor wire 91 is bent at an angle θ′ (see FIG. 30).

When the conductor wire 91 approaches the slot 9b, the arrangement of the conductor wire 91 is changed (in an arrangement changing portion 90c) so that the conductor wire 91 can enter a position 92d in the first stage of the slot inside SI. When this portion is observed from a side, the conductor wire 91 is bent at the angle θ″ (see FIG. 30).

The conductor wire 91 passing through the slot inside SI comes out from a position 92e (see FIG. 28). Then the arrangement of the conductor wire 91 is changed (in an arrangement changing portion 90d) so that the conductor wire 91 can come out to an area CE1b corresponding to the second stage of the slot inside SI. When this portion is observed from a side, the conductor wire 91 is bent at the angle θ (see FIG. 30).

The conductor wire 91 goes toward the slot 9a on the opposite side. When the conductor wire 91 reaches the intermediate position between the slot 9a and the slot 9b, the arrangement of the conductor wire 91 is changed (in a passing area changing portion 93a) so that the conductor wire 91 can pass through the area CE1a corresponding to the first stage of the slot inside SI again. When this portion is observed from a side, the conductor wire 91 is bent at the angle θ′.

In this manner, the conductor wire 91 forming the coil 717 is wound by one turn. Subsequently in the same manner, the conductor wire 91 is wound in the order of a position 92f, a position 92g, a position 92h, . . . , a position 92p, and a position 92q. In side view, four conductor wires 91 are arranged side by side in the coil end portion CE1, CE2.

In Embodiment 1, the conductor wires 11 are disposed so that the conductor wire 11 wound in the third turn can be located on the inner side of the conductor wire 11 wound in the second turn as shown in FIG. 6. Accordingly, in the coil 17, winding the conductor wires 11 are started on the upper side, and ended on the lower side.

On the other hand, according to this embodiment, the conductor wires 91 are disposed so that the conductor wire 91 wound in the third turn can be located on the outer side of the conductor wire 91 wound in the second turn as shown in FIG. 30. Accordingly, in the coil 717, winding the conductor wires 91 are started on the lower side, and ended on the upper side.

The stator windings 706 are formed in a method in which a plurality of coils 717 are disposed in the slot inside SI and terminals thereof are connected thereto by welding or the like. The method will be described in detail later. A plurality of coils 717 having one and the same shape may be used.

According to Embodiment 1, in order to connect the coils 17 in FIG. 6, a connection line for the connection must be a little longer because winding the conductor wires 11 is started on the upper side and ended on the lower side.

On the other hand, according to this embodiment, for example, two kinds of coils, that is, the coils 17 in FIG. 6 and the coils 717 in FIG. 30 are prepared. The coils 17 and the coils 717 are used alternately. Winding the conductor wires 11 is started on the upper side and ended on the lower side in each coil 17 in FIG. 6. Winding the conductor wires 91 is started on the lower side and ended on the upper side in each coil 717 in FIG. 30. Therefore, the two coils 17 and 717 can be connected through a connection line with a short distance (for example, shortest distance).

Thus, according to Embodiment 6, when two kinds of coils different in winding method are used together in order to connect a plurality of coils, the two can be connected through a connection line with a short distance (for example, shortest distance).

Incidentally, this Embodiment 6 has been described in contrast with Embodiment 1. However, the same technique can be also applied to Embodiments 2 to 5.

Incidentally, Embodiments 1 to 3 described the case where each coil has a hexagonal shape in side view. The coil is established on the following conditions about the number of stages in conductor wires and the bending angles of the conductor wires.

m is an integer of 2 or larger

n is an integer of 1 or larger

the bending angles θ and θ″ satisfy Expressions 2 and 3

the numbers of stages m and n satisfy Expression 1

To give further details, when n/m obtained by Expression 1 takes a maximum value (½), each conductor wire can be disposed so effectively (for example, most densely) that a useless space where no conductor wires are disposed can be substantially eliminated from each coil end portion. For example, this includes the case where the arrangement of conductor wires disposed in two stages in the radial direction of the stator core 5 in the slot inside SI is changed into one stage in the radial direction of the stator core 5 in each coil end portion CE1, CE2 as described in Embodiment 1.

On the other hand, a useless space where no conductor wires pass at all is present in each coil end portion CE1, CE2 when the value of n/m is smaller than ½ as in Embodiment 2 (where the arrangement of conductor wires disposed in three stages in the radial direction of the stator core 5 in the slot inside SI is changed into one stage in the radial direction of the stator core 5 in the coil end portion CE1, CE2) or as in Embodiment 3 (where the arrangement of conductor wires disposed in five stages in the radial direction of the stator core 5 in the slot inside SI is changed into two stages in the radial direction of the stator core 5 in the coil end portion CE1, CE2). Although it is ideal to produce a coil on the former condition (½) when stator windings of a rotary electrical machine are arranged, there may be an actual restriction in the number of stages due to the width of the slot inside, the height of the slot inside, and the wire diameter of the conductor wire. Therefore, stator windings of a rotary electrical machine may be produced with coils some of which are coils based on the latter condition (smaller than ½).

The following manner may be applied to any case of Embodiments 1 to 6 that have been described above.

For example, FIG. 31 is a view showing a state in which a coil has been inserted into a stator core, the state being observed from the top of the stator core. When a round wire is used as conductor wires 51, the conductor wires 51 forming a coil 817 in the slot inside SI may be stacked in a bale-piling shape as shown in FIG. 31. This is to improve the packing factor of the windings. However, by stacking the conductor wires 51 in the bale-piling shape, the height of the coil in the slot inside SI becomes low equivalently.

If the conductor wires 51 in each coil end portion CE1, CE2 are stacked in a bale-piling shape, the coil 817 can be formed on the same condition as the aforementioned Expression 1 because there is no difference in height required for the coil 817 between the slot inside SI and the coil end portion CE1. CE2.

However, when the conductor wires 51 in the coil end portion CE1, CE2 are not stacked in a bale-piling shape, only the height of the coil 817 in the slot inside SI becomes low equivalently. Due to the difference in height required for the coil 817 between the slot inside SI and the coil end portion CE1, CE2, the condition of Expression 1 is not established. In this case, assume that the height of the conductor wires 51 stacked in a bale-piling shape and disposed in m stages in the radial direction of the stator core 5 in the slot inside SI is equal to the height of the conductor wire stacked in a normal manner and disposed in m′ stages. In this case, the relation between m and m′ can be expressed by the following Expression 8.

m′=1+√3/2·(m−1)(m is an integer of 2 or larger) Expression 8

In this manner, in the coil 817, the arrangement of the conductor wires 51 disposed in m stages in the radial direction of the stator core 5 in the slot inside SI is changed into n stages in the radial direction of the stator core in each coil end portion CE1, CE2. In addition, the conductor wires 51 are bent at angles θ and θ″ in the slot inside SI and the coil end portion CE1, CE2. The arrangement of the conductor wires disposed from the first stage to the n-th stage in the radial direction of the stator core in the coil end portion is changed into windings disposed from the (m−n+1)th stage to m-th stage in the radial direction of the stator core. In addition, the conductor wires are bent at an angle θ′(=360−(θ+θ″)) between before and after the arrangement is changed. In the coil 817 configured thus, the conductor wires 51 can be stacked in a bale-piling shape in the slot inside SI on the following conditions:

m is an integer of 2 or larger

n is an integer of 1 or larger

the bending angles θ and θ″ satisfy Expressions 2 and 3

the numbers of stages m and n satisfy Expression 9

n/{1+√3/2·(m−1)}≦1/2 Expression 9

Thus, the packaging factor of the conductor wires 51 in the slot inside SI can be improved.

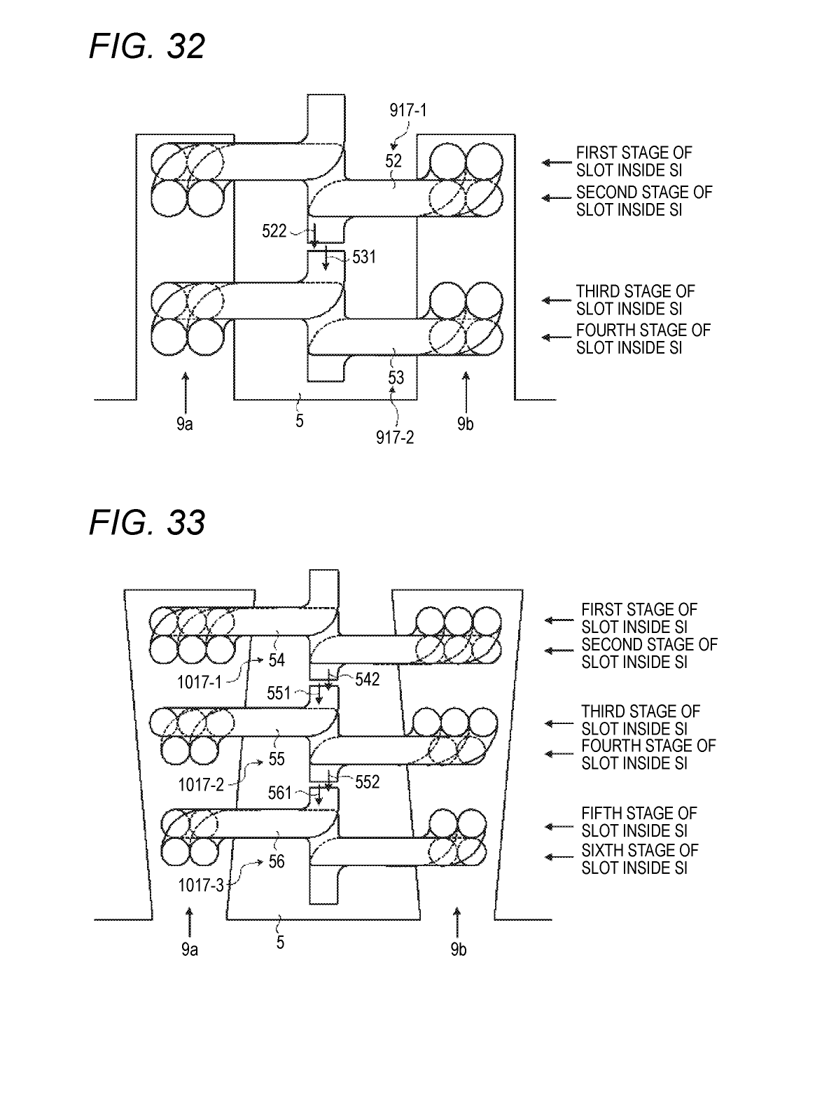

Alternatively, for example, FIG. 32 shows a state in which a coil has been inserted into a stator core, the state being observed from the top of the stator core. An example in which only one coil is put into the slot inside SI of the stator core 5 has been described so far. However, stator windings of a rotary electrical machine are often constituted by a plurality of coils disposed in the slot inside and connected to one another. FIG. 32 shows a state in which two coils (coils 917-1 and 917-2) have been inserted. In each of the coils, conductor wires 53 measuring two stages (in the radial direction of the stator core 5) by two lines (in the circumferential direction of the stator core 5) in the slot inside SI are arranged to measure one stage (in the radial direction of the stator core 5) by four lines (in the circumferential direction of the stator core 5) in each coil end portion CE1, CE2. In such a case, a winding end 522 of a conductor wire 52 in the first coil 917-1 is connected to a winding start 531 of a conductor wire 53 in the second coil 917-2 to form stator windings. Not to say, even when the number of coils to be inserted is increased, a winding end of a conductor wire in each coil may be connected (coupled) to a winding start of a conductor wire in the next coil. Thus, stator windings with a large number of stages in the radial direction of the stator core in the slot inside can be formed.

Alternatively, for example, FIG. 33 is a view showing a state in which coils have been inserted into a stator core, the state being observed from the top. When the stator core is a round-shaped stator core 5 as shown in FIG. 1, the shape of each slot is often formed in a trapezoidal shape rather than a rectangular shape for the following reason. That is, in order to make the teeth width constant, the slot width is often made narrower toward the inner circumference of the stator core 5 while the slot width is made wider toward the outer circumference of the stator core 5. FIG. 33 shows a state in which three coils 1017-1 to 1017-3 have been inserted into the slot inside SI of the stator core 5.

The coils 1017-1 to 1017-3 have conductor wires 54, 55 and 56 respectively. The numbers of windings of the conductor wires 54, 55 and 56 are changed in accordance with the width or height of the slot inside SI. In this manner, even when the shape of each slot 9a, 9b is not rectangular, some kinds of coils 1017-1 to 1017-3 having different numbers of windings of conductor wires 54, 55 and 56 are prepared in accordance with the shape of the slot 9a, 9b, and the coils 1017-1 to 1017-3 are connected to one another. Thus, it is possible to deal with any slot shape. Incidentally, the coils 1017-1 to 1017-3 form stator windings in such a manner that a winding end 542 of the conductor wire 54 in the first coil 1017-1 is connected to a winding start 551 of the conductor wire 55 in the second coil 1017-2, and a winding end 552 of the conductor wire 55 in the second coil 1017-2 is connected to a winding start 561 of the conductor wire 56 in the third coil 1017-3, as described previously.

Incidentally, in FIG. 32 or FIG. 33, description has been made about a method in which a plurality of coils are put in the slot inside SI of the stator core 5, and the winding start of one of the coils is connected to the winding end of another. In such a case, however, the coils may be connected to one another through connection lines in advance.

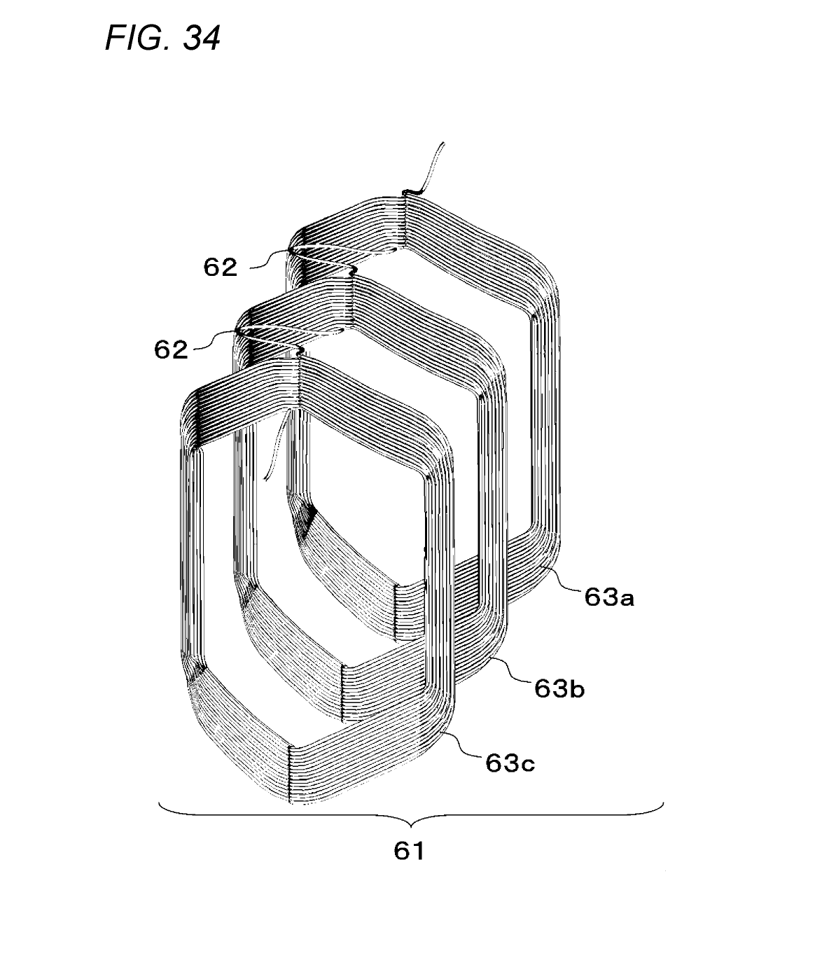

Alternatively, for example, FIG. 34 is a configuration view of a coil bundle forming stator windings. In this bundle, coils forming stator windings shown in FIG. 2 are connected through connection lines in advance. In a coil bundle 61, each coil is wound so that windings of the coil to be inserted into corresponding-phase slots adjacent to each other can be put on top of each other. In the coil bundle 61, three coils 63a, 63b and 63c are connected to one another through connection lines 62. In FIG. 34, each of the coils 63a, 63b and 63c is formed out of a conductor wire measuring in two stages (in the radial direction of the stator core 5) and eight lines (in the circumferential direction of the stator core 5) in the slot inside SI. However, the number in the radial direction and the number in the circumferential direction may be determined desirably.

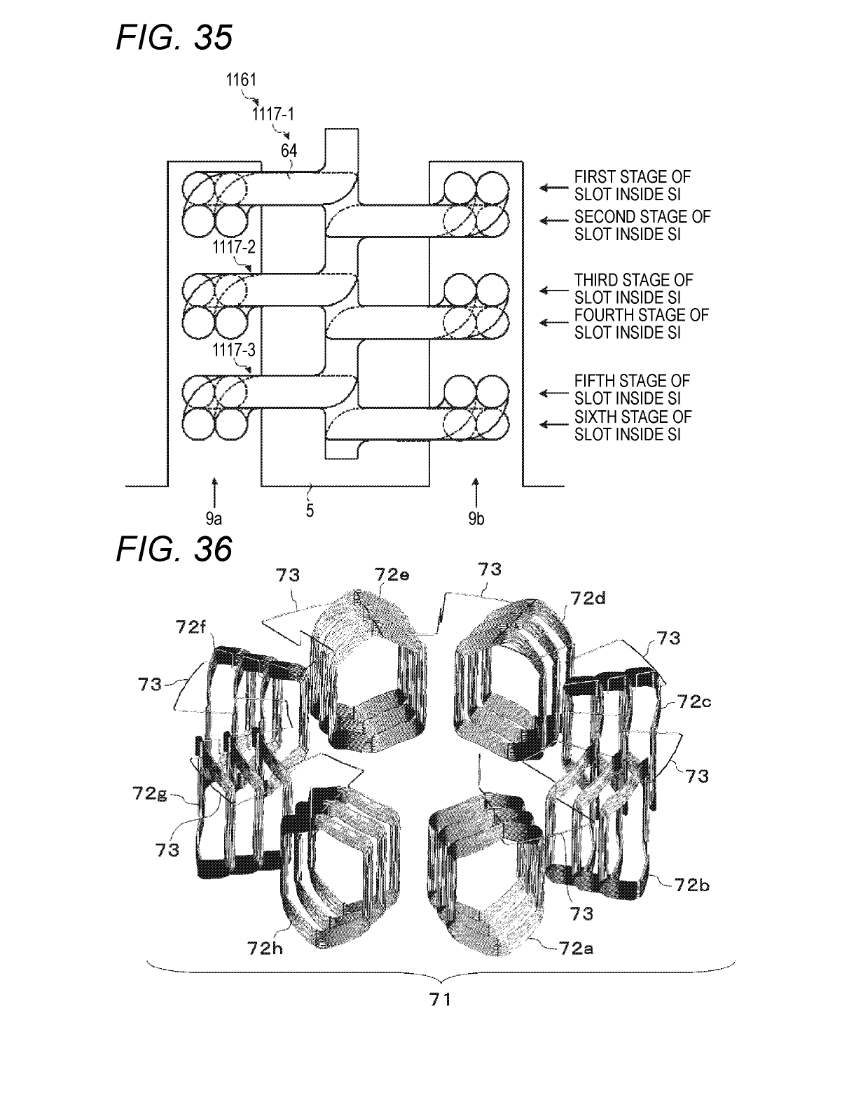

Alternatively, for example, FIG. 35 is a view showing a state in which coils have been inserted into a stator core, the state being observed from the top. FIG. 35 shows a state in which a coil bundle 1161 has been inserted. In the coil bundle 1161, three coils 1117-1 to 1117-3 are connected. In each of the coils 1117-1 to 1117-3, conductor wires 64 measuring two stages (in the radial direction of the stator core 5) by two lines (in the circumferential direction of the stator core 5) in the slot inside SI are arranged to measure one stage (in the radial direction of the stator core 5) by four lines (in the circumferential direction of the stator core 5) in each coil end portion CE1, CE2. In comparison with FIG. 32, the coils 1117-1 to 1117-3 are connected in advance. Thus, the work of connecting each inserted coil is not required, but working man hours can be reduced.

As described in Embodiments 1 to 6, winding a coil may be started at any position and ended at any position. However, when the winding end of the coil is disposed on a line connecting the winding start of the coil and the center of a stator core (the position of the winding start and the position of the winding end are aligned with each other in the circumferential direction of the stator core), there can be obtained an advantage that the work of connecting a plurality of coils or coupling them in advance can be made easier, or connection lines can be shortened.

Particularly, when each coil has a hexagonal shape in side view, it is preferable that the winding end of the coil is disposed on a line connecting the winding start of the coil and the center of a stator core, and the position of the winding end is set as an apex of a coil end portion having a triangular shape (the position of the winding start and the position of the winding end are aligned with the apex of the coil end portion in the circumferential direction of the stator core). In this manner, there can be obtained an advantage that when a plurality of coils are connected to one another or coupled with one another in advance, a line connecting the coils can be prevented from interfering with stator windings of another phase.

In FIG. 34, description has been made about a coil bundle forming stator windings to be inserted into the slot inside. In order to form stator windings of a rotary electrical machine, all coil bundles inserted into slots must be further connected finally. Accordingly, the coil bundles may be connected through connection lines so as to form a large coil group corresponding to stator windings for each phase.

For example, FIG. 36 is a configuration view of a coil group forming stator windings. In the coil group, coil bundles forming stator windings as shown in FIG. 34 are connected through connection lines in advance. A coil group 71 in FIG. 36 shows a state in which coil bundles 72a to 72h are connected in series through connection lines 73. Stator windings of a rotary electrical machine may include various patterns such as a pattern in which all windings of slots are connected in series, a pattern in which windings of slots are divided into halves to be connected in parallel, etc. FIG. 36 shows a case in which all the windings of the slots are connected in series. However, for example, coil bundles 72a to 72d may be connected through connection lines in advance while coil bundles 72e to 72h are connected through connection lines in advance. When the two are connected in parallel, two parallel stator windings can be formed. In this manner, when a coil group in which coil bundles are connected in advance is prepared, the number of times of connection work can be reduced on a large scale, contributing to reduction in working man hours.

In addition, Embodiments 1 to 6 have been described mainly in the case where the number of slots in each pole and each phase is two (8 poles and 48 slots). However, the number of phases and the number of slots are not restricted especially. The invention can be applied to another combination.

In addition, Embodiments 1 to 6 has been described on the assumption that conductor wires are round wires. However, there is no restriction about the sectional shape of each conductor wire in the invention. Square wires etc. other than the round wires may be used. Incidentally, square wires are characterized in that they can increase the packaging factor of windings in the slot inside, but they are poor in workability. On the contrary, round wires are characterized in that they are good in workability, but they cannot increase the packaging factor of windings in the slot inside. For the sake of good use of the both, there is a method in which coils are made of round wires good in workability, and only conductor wires corresponding to the slot inside are formed in sectionally square shapes by press molding to thereby increase the packaging factor.

However, when only the sectional shapes of the conductor wires corresponding to the slot inside are formed in square shapes, the height of the coil in the slot inside becomes low equivalently. If the sectional shapes of conductor wires in each coil end portion are also formed in square shapes, the height required for the coil can be kept uniform between the slot inside and the coil end portion. Thus, the coil can be formed with the condition of the aforementioned Expression 1 as it is. However, when the sectional shapes of the conductor wires in the coil end portion are not formed in square shapes, only the height of the coil in the slot inside becomes low equivalently. Due to a difference in height required for the coil between the slot inside and the coil end portion, the condition of Expression 1 is not established.

Assume that the height of a conductor wire having a square shape in section and disposed in m stages in the radial direction of the stator core in the slot inside is equal to the height of a round conductor wire disposed in m′ stages. In this case, the relation between m and m′ can be expressed by the following Expression 10.

m′=√(π/4)·m (m is an integer of 2 or larger) Expression 10

In this manner, in the coil, the arrangement of the conductor wire 51 disposed in m stages in the radial direction of the stator core 5 in the slot inside SI is changed into n stages in the radial direction of the stator core in each coil end portion CE1, CE2. In addition, the conductor wire 51 is bent at angles θ and θ″ in the slot inside SI and the coil end portion CE1, CE2. The arrangement of the conductor wire disposed from the first stage to the n-th stage in the radial direction of the stator core in the coil end portion is changed into windings disposed from the (m−n+1)th stage to m-th stage in the radial direction of the stator core. In addition, the conductor wire is bent at an angle θ′(=360−(θ+θ″)) between before and after the arrangement is changed. In the coil configured thus, only the sectional shape of the conductor wires corresponding to the slot inside may be formed in a square shape on the following conditions:

m is an integer of 2 or larger

n is an integer of 1 or larger

the bending angles θ and θ″ satisfy Expressions 2 and 3

the numbers of stages m and n satisfy Expression 11

n/{√(π/4)·m}≦1/2 Expression 11

Thus, the packaging factor of the conductor wires in the slot inside SI can be improved.

The rotary electrical machines 1, 200, 400, 500, 600 and 700 according to Embodiments 1 to 6 and modifications thereof have been described above.

### Embodiment 7

Next, a rotary electrical machine according to Embodiment 7 will be described. Incidentally, in order to explain the rotary electrical machine according to Embodiment 7, description will be first made about problems in the rotary electrical machines 1, 200, 400, 500, 600 and 700 according to Embodiments 1 to 6.

A rotary electrical machine 1200 is assumed as equivalent to any one of the rotary electrical machines 1, 200, 400, 500, 600 and 700 according to Embodiments 1 to 6 and modifications thereof. Stator windings 1206 are inserted into slots 9 belonging to a stator core 5 of a stator 1203. The rotary electrical machine 1200 is formed thus. The stator windings 1206 are arranged by a plurality of coils 1217. Each coil 1217 is any one of the coils 17, 63a, 63b, 63c, 217, 417, 517, 617, 717, 817, 917, 1017 and 1117 according to Embodiments 1 to 6 and modifications thereof described above.

Next, description will made about the relationship between reduction in height of each coil end portion and interference among the coils 1217 in the rotary electrical machine 1200. In the rotary electrical machine 1200 according to Embodiments 1 to 6 and modifications thereof, interference among the coils 1217 occurs when the height of each coil end portion in each coil 1217 is reduced.

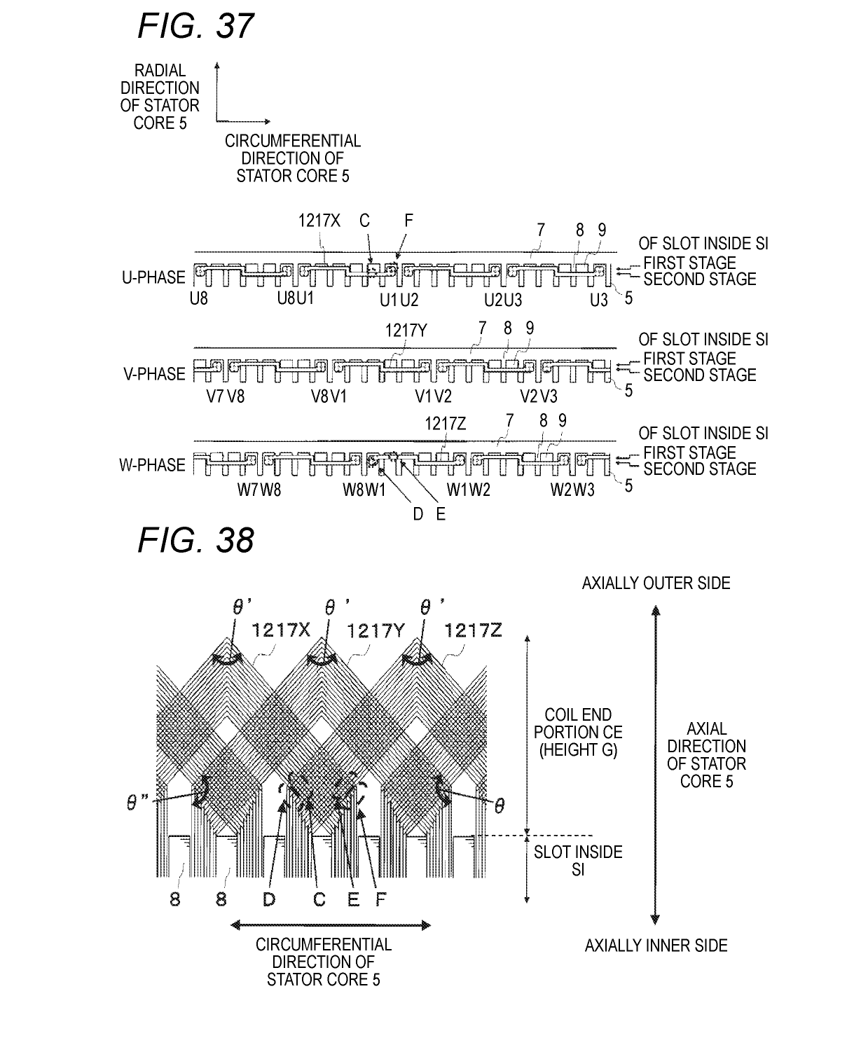

FIG. 37 is a configuration view of windings for each phase of a stator in which coils have been inserted into a stator core according to Embodiment 7. The stator core 5 in FIG. 37 is depicted as a straight line shape for the sake of easiness of explanation, and halfway parts thereof are not shown. Incidentally, in FIG. 37, the coils 1217 are illustrated as similar ones to the coils 17 in Embodiment 1. However, the coils 1217 may be similar to the coils 63a, 63b, 63c, 217, 417, 517, 617, 717, 817, 917, 1017 and 1117.

FIG. 38 is a view in which a coil end portion CE is observed from the inside of a stator core after coils according to Embodiments 1 to 6 and modifications thereof have been inserted into slots. In FIG. 38, a coil 1217X, a coil 1217Y and a coil 1217Z are the coils 1217.

In Embodiments 1 to 6 and modifications thereof, a part C of the coil 1217X shown in FIG. 37 is located on the outer side of a part D of the coil 1217Z in the axial direction of the stator core 5 in FIG. 38. In addition, a part E of the coil 1217Z shown in FIG. 37 is located on the outer side of a part F of the coil 1217X in the axial direction of the stator core 5 in FIG. 38. In addition, in the case of FIG. 38, there occurs no interference among the coil 1217X, the coil 1217Y and the coil 1217Z inserted into the respective slots 9. The height of the coil end portion CE on this occasion is height G.

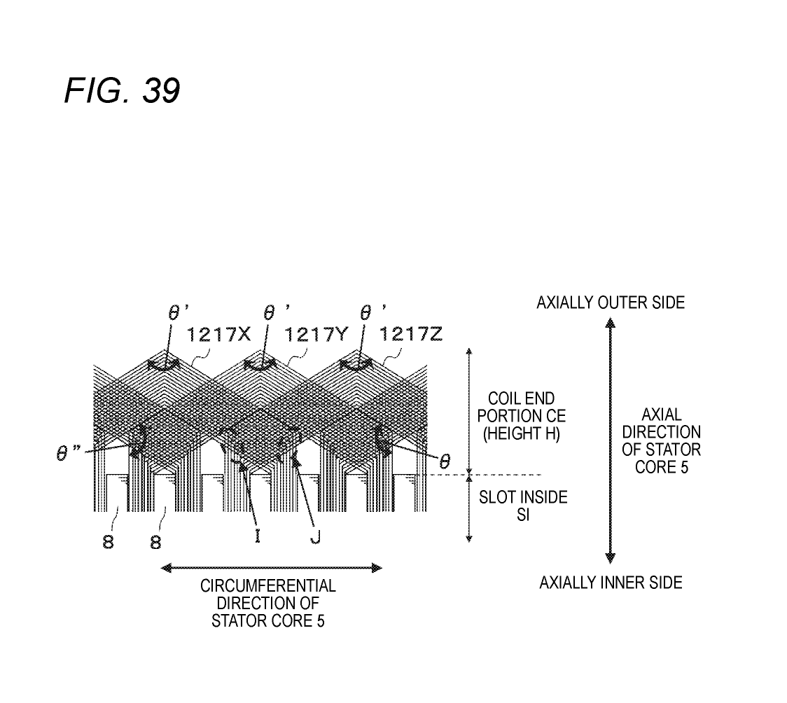

FIG. 39 is a view in which a coil end portion CE is observed from the inside of a stator core after coils according to Embodiments 1 to 6 and modifications thereof have been inserted into slots. FIG. 39 is a view showing a case where the height of the coil end portion CE is lower than that in FIG. 38. In FIG. 39, a coil 1217X, a coil 1217Y and a coil 1217Z are the coils 1217. In addition, in FIG. 39, height H of the coil end portion CE is lower than the height G of the coil end CE in the case shown in FIG. 38. That is, FIG. 39 shows a case where the height of the coil end CE in each of the coil 1217X, the coil 1217Y and the coil 1217Z is made lower than that in FIG. 38.

In FIG. 39, interference between the coil 1217X and the coil 1217Z occurs in a part I and a part J. In the part I, the part C of the coil 1217X and the part D of the coil 1217Z shown in FIG. 37 interfere with each other. In addition, in the part J, the part E of the coil 1217Z and the part F of the coil 1217X shown in FIG. 37 interfere with each other.

Incidentally, in order to avoid interference, a conductor wire in the part where the interference occurs must be made to take a detour. In this case, the thickness of windings in the coil 1217 increases only in the part where the interference occurs. Thus, the coil end portion CE expands in the radial direction of the stator core 5. As a result, the total circumferential length of the stator windings 1206 is increased. Accordingly, the resistance value of the stator windings 1206 increases to increase the copper loss in the rotary electrical machine 1, that is, the energy loss in the rotary electrical machine 1. Thus, the operating efficiency of the rotary electrical machine 1 is lowered.

Therefore, according to Embodiment 7, further additional bent portions are provided in coils according to the aforementioned Embodiments 1 to 6 and modifications thereof in order to prevent interference from occurring among the coils when the height of each coil end portion CE is reduced.

Next, a rotary electrical machine 1300 according to Embodiment 7 will be described. The rotary electrical machine 1300 has a different configuration in each coil 1317 as compared with the rotary electrical machines 1, 200, 400, 500, 600 and 700 according to Embodiments 1 to 6 described above. In addition, as for the other configuration than the coil 1317, the rotary electrical machine 1300 according to Embodiment 7 is similar to the rotary electrical machines 1, 200, 400, 500, 600 and 700 according to Embodiments 1 to 6 and modifications thereof described above.

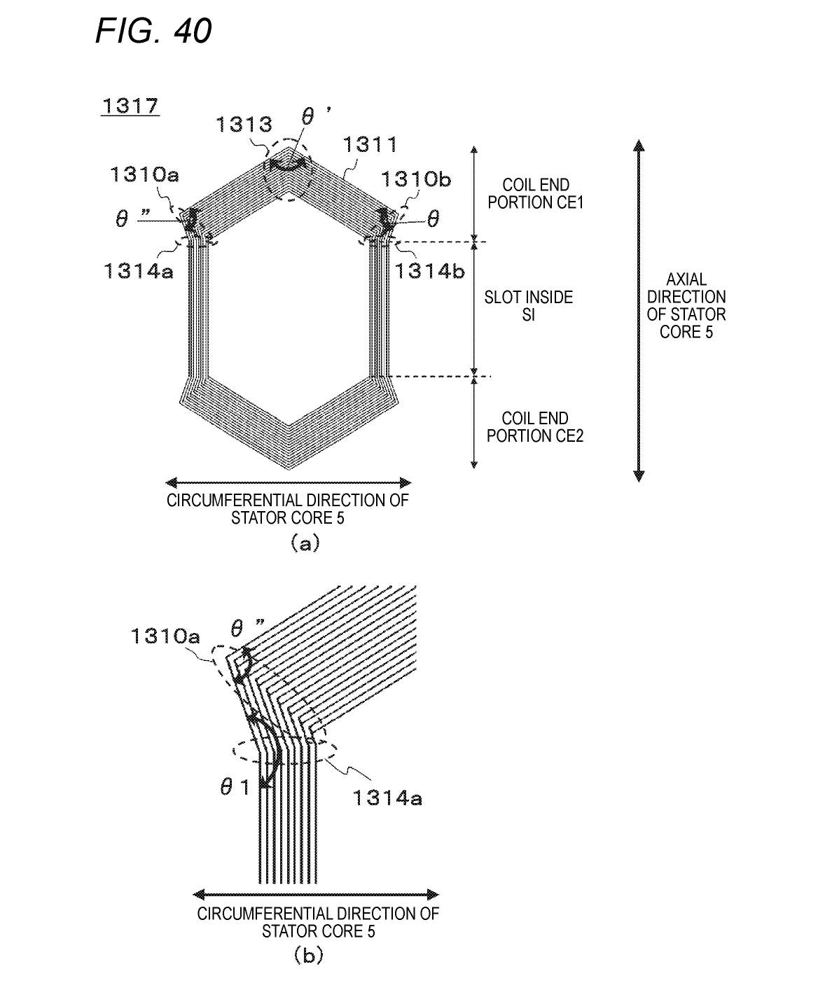

A stator 1303 of the rotary electrical machine 1300 according to Embodiment 7 is constituted by a stator core 5 and stator windings 1306. FIG. 40-(a) is a view of a coil forming the stator windings of the rotary electrical machine according to Embodiment 7. The stator windings 1306 are constituted by a plurality of coils 1317 shown in FIG. 40-(a). As shown in FIG. 40-(a), each coil 1317 is a coil in which an outside bent portion 1314a and an outside bent portion 1314b are further provided in any one of the coils 17, 63a, 63b, 63c, 217, 417, 517, 617, 717, 817, 917, 1017 and 1117 according to Embodiments 1 to 6 described above.

FIG. 40-(b) is an enlarged view of an outside bent portion of the coil according to Embodiment 7. A coil 21 has an outside bent portion 1314a in a coil end portion CE1 forward from a slot inside SI, as shown in FIG. 40-(a) and FIG. 40-(b). In the outside bent portion 1314a, all the conductor wires 1311 forming the coil 1317 are bent at an angle θ1 in the circumferential direction of the stator core 5 as shown in FIG. 40-(b).

On this occasion, in the outside bent portion 1314a, the coil 1317 is bent in the circumferential direction of the stator core 5 and in the opposite direction to an apex 1313 of the coil end portion CE1. In addition, all the conductor wires 1311 forming the coil 1317 are bent outward beyond the width of the slot inside SI. Thus, the angle θ1 is an angle satisfying the following Expression 12. Incidentally, the angle θ1 is 200° in Embodiment 7.

θ1>180° Expression 12

In addition, in the coil end portion CE1 forward from the outside bent portion 1314a, the coil 1317 has an arrangement changing portion 1310a as shown in FIG. 40-(a) and FIG. 40-(b). The coil 1317 changes the arrangement of windings in the arrangement changing portion 1310a in the same manner as in Embodiments 1 to 6.

In the coil 1317, therefore, the radial thickness of the coil 1317 is thinner in the coil end portion CE1 than the radial thickness in the slot inside SI. Accordingly, winding positions in the coil 1317 can be prevented from radially interfering with another coil 1317 of another phase in the stator windings 1306. In addition, on this occasion, the coil 1317 is bent at an angle θ″ in the arrangement changing portion 1310a as shown in FIG. 40-(b). The angle θ″ is 100° in Embodiment 7.

In addition, the coil 1317 is also bent at an angle θ′ in the apex 1313 of the coil end portion CE1 as shown in FIG. 40-(a). The angle θ′ is 120° in Embodiment 7.

Further, the coil 1317 has an arrangement changing portion 1310b forward from the apex 1313 of the coil end portion CE1. The coil 1317 changes the arrangement of windings in the arrangement changing portion 1310b in the same manner as in Embodiments 1 to 6. In addition, also on this occasion, the coil 1317 is bent at an angle θ in the arrangement changing portion 1310b as shown in FIG. 40-(a). The angle θ is 100° in Embodiment 7.

Furthermore, the coil 1317 has an outside bent portion 1314b in a part coming back from the coil end portion CE1 toward the slot inside SI again. In the outside bent portion 1314b, all the conductor wires 1311 forming the coil 1317 are bent at the angle θ1 in the circumferential direction of the stator core 5.

In the outside bent portion 1314b, the coil 1317 is bent in the circumferential direction of the stator core 5 and in the opposite direction to the apex 1313 of the coil end portion CE1. On this occasion, all the conductor wires 1311 forming the coil 1317 are bent outward beyond the width of the slot inside SI. The angle θ1 on this occasion is also set at an angle satisfying the aforementioned Expression 12. Incidentally, the angle θ1 is 200° in Embodiment 7.

Due to such a configuration, the coil 1317 is formed in a shape having a larger number of bent portions than the coil 1217 in any one of the rotary electrical machines 1, 200, 400, 500, 600 and 700 according to Embodiments 1 to 6 and modifications thereof. In addition, though not shown, on the coil end portion CE2 side, the coil 1317 has a similar configuration to that on the coil end portion CE1 side. Thus, the coil 1317 has a decagonal shape as a whole.

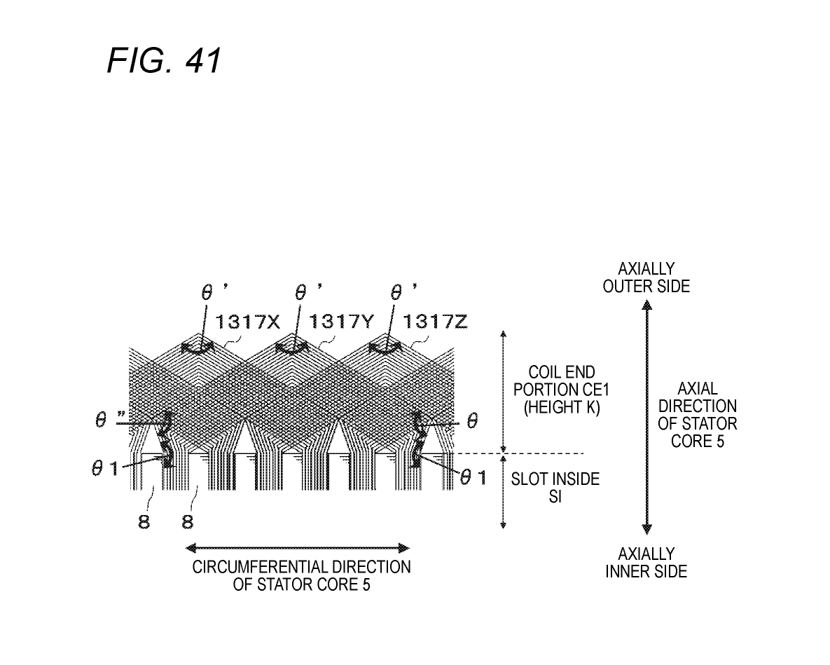

FIG. 41 is a view in which a coil end portion CE is observed from the inside of a stator core after coils according to Embodiment 7 have been inserted into slots. In the rotary electrical machine 1300 according to Embodiment 7, a plurality of coils 1317 configured thus are inserted into slots 9 of a stator core 5. In FIG. 41, a coil 1317X, a coil 1317Y and a coil 1317Z are the coils 1317. In addition, in FIG. 41, height K of a coil end portion CE1 in each coil 1317 according to Embodiment 7 is lower than the height G of the coil end portion CE in the case shown in FIG. 38.

In the outside bent portion 1314a and the outside bent portion 1314b, the coil 1317 is bent in the circumferential direction of the stator core 5 and in the opposite direction to the apex 1313 of the coil end portion CE1 as described above. Accordingly, even when the height K of the coil end portion CE1 in the coil 1317 is made lower than the height G of the coil end portion CE1 in the case shown in FIG. 38, the coil 1317X, the coil 1317Y and the coil 1317Z inserted into the slots 9 do not interfere with one another, as shown in FIG. 41.

In the outside bent portion 1314a and the outside bent portion 1314b, the coil 1317 according to Embodiment 7 is bent in the circumferential direction of the stator core 5 and in the opposite direction to the apex 1313 of the coil end portion CE1 as described above. The bending direction in the outside bent portion 1314a is also opposite to the bending direction at the angle θ″ in the arrangement changing portion 1310a. In addition, the bending direction in the outside bent portion 1314b is also opposite to the bending direction at the angle θ in the arrangement changing portion 1310b.

On this occasion, in the outside bent portion 1314a and the outside bent portion 1314b, all the conductor wires 1311 forming the coil 1317 are bent outward beyond the width of the slot inside SI. In addition, the shape of the coil end portion CE2 is formed similarly to the shape of the coil end portion CE1. That is, the coil 1317 as a whole has a decagonal shape in which the coil end portion CE1 and the coil end portion CE2 expand on the outer side from the slot inside SI. Due to such a configuration, the stator windings 1306 of the rotary electrical machine 1300 according to Embodiment 7 can prevent occurrence of any part where windings of one phase may interfere with windings of another phase. Thus, the total circumferential length of the stator windings 1306 can be shortened to reduce the resistance value of the stator windings 1306 and reduce the loss in the rotary electrical machine 1300. It is therefore possible to improve the operating efficiency of the rotary electrical machine 1300.

In addition, at each bent place of the coil 1317, all the conductor wires 1311 forming the coil 1317 are bent at the same angle. Accordingly, the stator windings 1306 of the rotary electrical machine 1300 according to Embodiment 7 can prevent any unnecessary gap from occurring in the coil end portion CE1 and the coil end portion CE2. In addition, lengths and angles of the coil 1317 are assigned clearly in the stator windings 1306 of the rotary electrical machine 1300 according to Embodiment 7. Accordingly, the dimensional accuracy of the coil 1317 can be improved, so that interference between the coil 1317 and an adjacent coil 1317 of another phase in the stator windings 1306 can be prevented more surely.

### Embodiment 8

Next, a stator 1403 of a rotary electrical machine 1400 according to Embodiment 8 will be described. The rotary electrical machine 1400 according to Embodiment 8 has a different configuration of each coil 1417 as compared with the rotary electrical machine 1300 according to Embodiment 7. In addition, as for the other configuration than the coil 1417, the rotary electrical machine 1400 according to Embodiment 8 is similar to the rotary electrical machine 1300 according to Embodiment 7. Therefore, only the configuration of the coil 1417 will be described, and description of the other configuration than the coil 1417 will be omitted.

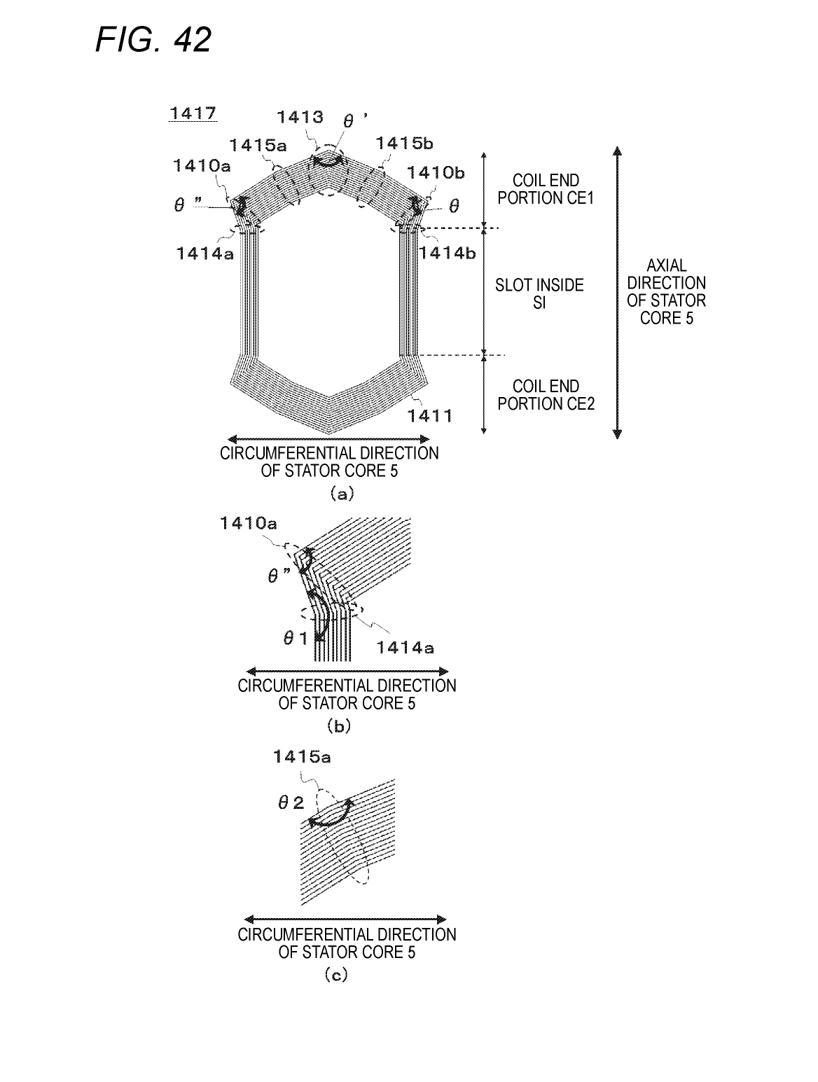

FIG. 42-(a) is a view of a coil forming the stator windings of the rotary electrical machine according to Embodiment 8. The coil 1417 is a coil in which an inside bent portion 1415a and an inside bent portion 1415b are further provided in the coil 1317 according to Embodiment 7 as shown in FIG. 42-(a).

FIG. 42-(b) is an enlarged view of an outside bent portion of the coil according to Embodiment 8. The coil 1417 has an outside bent portion 1414a in a coil end portion CE1 forward from a slot inside SI, as shown in FIG. 42-(a) and FIG. 42-(b). In the outside bent portion 1414a, all conductor wires 1411 forming the coil 1417 are bent at an angle θ1 in the circumferential direction of the stator core 5 as shown in FIG. 42-(b).

On this occasion, in the outside bent portion 1414a, the coil 1417 is bent in the circumferential direction of the stator core 5 and in the opposite direction to an apex 1413 of a coil end portion CE1. In addition, all the conductor wires 1411 forming the coil 1417 are bent outward beyond the width of the slot inside SI. The angle θ1 on this occasion is set at an angle satisfying the aforementioned Expression 12. Incidentally, the angle θ1 is 205° in Embodiment 8.

In addition, in the coil end portion CE1 forward from the outside bent portion 1414a, the coil 1417 has an arrangement changing portion 1410a similar to the arrangement changing portion 1310a in Embodiment 7, as shown in FIG. 42-(a) and FIG. 42-(b). The coil 1417 changes the arrangement of windings in the arrangement changing portion 1410a.

Therefore, the radial thickness of the coil 1417 in the coil end portion CE1 is thinner than the radial thickness in the slot inside SI. Accordingly, winding positions in the coil 1417 can be prevented from radially interfering with another coil 1417 of another phase in the stator windings 1406. In addition, on this occasion, the coil 1417 is bent at an angle θ″ in the arrangement changing portion 1410a as shown in FIG. 42-(b). The angle θ″ is 110° in Embodiment 8.

FIG. 42-(c) is an enlarged view of an inside bent portion of the coil according to Embodiment 8. In the coil 1417 according to Embodiment 8, the inside bent portion 1415a is provided between the arrangement changing portion 1410a and the apex 1413 of the coil end portion CE1 as shown in FIG. 42-(c). In the inside bent portion 1415a, all the conductor wires 1411 forming the coil 1417 are bent at an angle θ2 in the circumferential direction of the stator core 5 as shown in FIG. 42-(c).

In addition, the angle θ2 on this occasion is set at an angle satisfying the following Expression 13. Incidentally, the angle θ2 is 160° in Embodiment 8.

θ2<180° Expression 13

In addition, the coil 1417 is also bent at an angle θ′ in the apex 1413 of the coil end portion CE1 as shown in FIG. 42-(a). The angle θ′ is 130° in Embodiment 8.

In the coil 1417 according to Embodiment 8, the inside bent portion 1415b is also provided between the apex 1413 of the coil end portion CE1 and the arrangement changing portion 1410b. In the inside bent portion 1415b, all the conductor wires 1411 forming the coil 1417 are bent at the angle θ2 in the circumferential direction of the stator core 5. The angle θ2 on this occasion is also set at an angle satisfying the aforementioned Expression 13. Incidentally, the angle θ2 is 160° in Embodiment 8.

Further, the coil 1417 changes the arrangement of windings in the arrangement changing portion 1410b in the same manner as in Embodiment 7. In addition, also on this occasion, the coil 1417 is bent at the angle θ in the arrangement changing portion 1410b as shown in FIG. 42-(a). The angle θ is 110° in Embodiment 8.

Furthermore, the coil 1417 has an outside bent portion 1414b in a part coming back from the coil end portion CE1 toward the slot inside SI again. In the outside bent portion 1414b, all the conductor wires 1411 forming the coil 1417 are bent at the angle θ1 in the circumferential direction of the stator core 5. The angle θ1 on this occasion is also set at an angle satisfying the aforementioned Expression 12. Incidentally, the angle θ1 is 205° in Embodiment 8.

Due to such a configuration, the coil 1417 is formed in a shape having a further larger number of bent portions than the coil 1317 in the rotary electrical machine 1300 according to Embodiment 7. In addition, though not shown, on the coil end portion CE2 side, the coil 1417 has a similar configuration to that on the coil end portion CE1 side. Thus, the coil 1417 has a tetradecagonal shape as a whole.

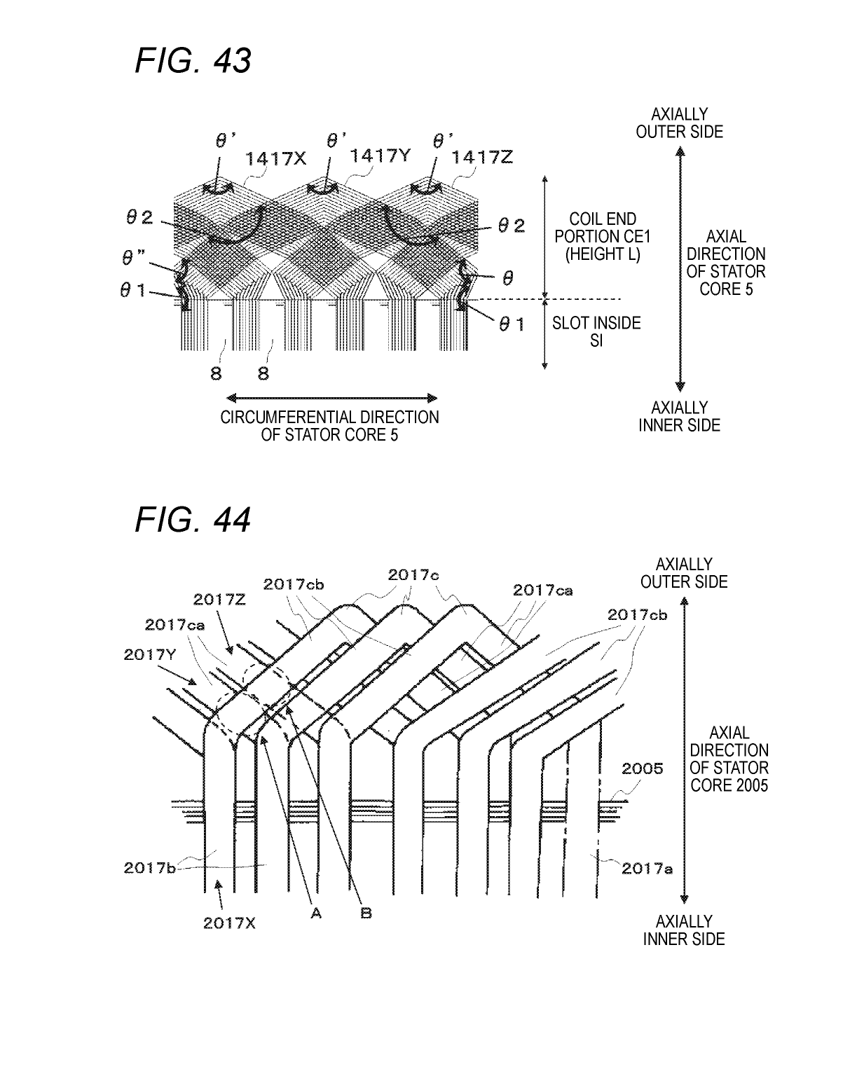

FIG. 43 is a view in which a coil end portion CE is observed from the inside of a stator core after coils according to Embodiment 8 have been inserted into slots. In the rotary electrical machine 1400 according to Embodiment 8, a plurality of coils 1417 configured thus are inserted into slots 9 of a stator core 5. In FIG. 43, a coil 1417X, a coil 1417Y and a coil 1417Z are the coils 1417. In addition, in FIG. 43, height L of a coil end portion CE1 in each coil 1417 according to Embodiment 8 is lower than the height G of the coil end portion CE1 in the case shown in FIG. 38. In addition, the height L of the coil end portion CE1 in the coil 1417 according to Embodiment 8 is lower than the height K of the coil end portion CE1 in the coil 1317 according to Embodiment 7 shown in FIG. 41.

In the outside bent portion 1414a and the outside bent portion 1414b, the coil 1417 is bent in the circumferential direction of the stator core 5 and in the opposite direction to the apex 1413 of the coil end portion CE1 as described above. In addition, in the coil 1417, the inside bent portion 1415a and the inside bent portion 1415b are further added in the coil end portion CE1. Accordingly, even when the height L of the coil end portion CE1 in the coil 1417 is made lower than the height G of the coil end portion CE1 in the case shown in FIG. 38, the coil 1417X, the coil 1417Y and the coil 1417Z inserted into the slots 9 do not interfere with one another, as shown in FIG. 43. In addition, even when the height L of the coil end portion CE1 in the coil 1417 is made lower than the height K of the coil end portion CE1 in the coil 1317 according to Embodiment 7, the coil 1417X, the coil 1417Y and the coil 1417Z inserted into the slots 9 do not interfere with one another.

In the outside bent portion 1414a and the outside bent portion 1414b, the coil 1417 according to Embodiment 8 is bent in the circumferential direction of the stator core 5 and in the opposite direction to the apex 1413 of the coil end portion CE1 as described above. The bending direction in the outside bent portion 1414a is also opposite to the bending direction at the angle θ″ in the arrangement changing portion 1410a. In addition, the bending direction in the outside bent portion 1414b is also opposite to the bending direction at the angle θ in the arrangement changing portion 1410b.

On this occasion, in the outside bent portion 1414a and the outside bent portion 1414b, all the conductor wires 1411 forming the coil 1417 are bent outward beyond the width of the slot inside SI. In addition, in the coil 1417 according to Embodiment 8, the inside bent portion 1415a and the inside bent portion 1415b serving as additional bent portions are provided in the coil end portion CE1. The shape of the coil end portion CE2 is formed similarly to the shape of the coil end portion CE1. That is, the coil 1417 as a whole has a tetradecagonal shape in which the coil end portion CE1 and the coil end portion CE2 expand on the outer side from the slot inside SI. Due to such a configuration, the stator windings 1406 of the rotary electrical machine 1400 according to Embodiment 8 can prevent occurrence of any part where windings of one phase may interfere with windings of another phase. In addition, the bent portions in the coil end portion CE1 are added in the stator windings 1406 of the rotary electrical machine 1400 according to Embodiment 8. Accordingly, the height of the coil end portion CE1 can be further reduced as compared with that in Embodiment 7. Thus, the total circumferential length of the stator windings 1406 can be shortened to reduce the resistance value of the stator windings 1406 and reduce the loss in the rotary electrical machine 1400. It is therefore possible to improve the operating efficiency of the rotary electrical machine 1400.

In addition, at each bent place of the coil 1417, all the conductor wires 1411 forming the coil 1417 are bent at the same angle. Accordingly, the stator windings 1406 of the rotary electrical machine 1400 according to Embodiment 8 can prevent any unnecessary gap from occurring in the coil end portion CE1 and the coil end portion CE2. In addition, lengths and angles of the coil 1417 are assigned clearly in the stator windings 1406 of the rotary electrical machine 1400 according to Embodiment 8. Accordingly, the dimensional accuracy of the coil 1417 can be improved, so that interference between the coil 1417 and an adjacent coil 1417 of another phase in the stator windings 1406 can be prevented more surely.

Incidentally, in Embodiment 8, the coil 1417 is provided with the inside bent portion 1415a and the inside bent portion 1415b and formed in a tetradecagonal shape as a whole. However, the shape is not limited to this. For example, in the coil end portion CE1, another bent portion having an angle θ3 (03<180°) may be added to further increase the number of sides of a polygon. In this manner, the height of the coil end portion CE1 can be further reduced.

Incidentally, it has been described that the coil 1317 is formed in a decagonal shape in Embodiment 7, and the coil 1417 is formed in a tetradecagonal shape in Embodiment 8. The shapes are not limited to those. The shape of the coil 1317 or the coil 1417 may be another polygonal shape if it is formed in a shape in which all the conductor wires 1311 or the conductor wires 1411 can be bent outward beyond the width of the slot inside SI to further additionally increase bent portions in places coming from the slot inside SI to the coil end portion CE1.

In addition, the height of the coil end portion CE1 may be reduced not by the polygonal shape in which bent portions are increased but by a curved shape in the coil end portion CE1. That is, the coil 1317 or the coil 1417 may be once bent outward beyond the width of the slot inside SI and then formed in a curved shape. In this manner, the shape of the coil end portion CE1 may be formed in a fan shape as a whole.

In addition, when all the coils 1317 or the coils 1417 inserted into the respective slots 9 are formed in the same shape, there is an upper limit in the quantity that can be expanded outward beyond the width of the slot inside SI. That is, in order to produce interference between adjacent ones of the coils, the quantity that can be expanded outward must be made not larger than half the distance between the slots 9.

However, in Embodiment 7 or Embodiment 8, all the shapes of the coils 1317 or the coils 1417 inserted into the respective slots 9 do not have to be formed in the same shape. In this case, it is possible to devise parts where the conductor wire 1311 or the conductor wire 1411 is bent outward. For example, the parts in adjacent ones of the coils may be displaced from each other in the height direction of the coil end CE1. Thus, the quantity that can be expanded outward can be made larger than half the distance between the slots 9 in the stator windings 1306 of the rotary electrical machine 1300 according to Embodiment 7 and the stator windings 1406 of the rotary electrical machine 1400 according to Embodiment 8.

In Embodiment 7 or Embodiment 8, the configuration of the coil end portion CE2 is similar to the configuration of the coil end portion CE1. Accordingly, the same thing as the aforementioned description made for the coil end portion CE1 can be applied to the coil end portion CE2.

Description has been made so far on the assumption that all the conductor wires 1311 or the conductor wires 1411 forming the coil 1317 or the coil 1417 are bent outward beyond the width of the slot inside SI. However, the stator windings 1306 of the rotary electrical machine 1300 according to Embodiment 7 and the stator windings 1406 of the rotary electrical machine 1400 according to Embodiment 8 are not limited thereto. In Embodiment 7 or Embodiment 8, only the innermost winding of the conductor wire 1311 or the conductor wire 1411 in the coil 1317 or the coil 1417 does not have to be bent outward.

Incidentally, in Embodiment 7 and Embodiment 8, the number of poles and the number of slots are not restricted especially. The effects according to Embodiment 7 and Embodiment 8 can be obtained in various combinations as to the number of poles and the number of slots.

In addition, in any one of the cases described so far, description was made in such a procedure that coils each changing the arrangement of conductor wires between a slot inside and a coil end portion are produced in advance, and each of the coils are inserted into the slot inside. However, it will go well by a procedure in which conductor wires are wound around a stator core to form coils each changing the arrangement of stator windings between a slot inside and a coil end portion to thereby complete the stator windings.

Incidentally, in the aforementioned description, the circumferential direction of the stator core 5 is identical to the circumferential direction of the core back 7. The radial direction of the stator core 5 is identical to the radial direction of the core back 7.

Incidentally, description has been made along a rotary electrical machine herein. Therefore, the stator core is formed in a round shape. However, the invention can be also applied to a stator core having a linear shape. Accordingly, the invention can be applied not only to the rotary electrical machine but also to a linear motion machine such as a linear motor.

### DESCRIPTION OF REFERENCE NUMERALS AND SIGNS

1, 200, 400, 500, 600, 700, 1200, 1300, 1400 rotary electrical machine,
2 rotor,
2a rotator core,
2b permanent magnet,
3, 203, 403, 503, 603, 703, 1203, 1303, 1403 stator,
5 stator core,
6, 206, 406, 506, 606, 706, 1206, 1306, 1406 stator windings,
7 core back,
8 teeth,
9 slot,
11, 21, 31, 41, 81, 91, 1311, 14111 conductor wire,
1314a, 1314b, 1414a, 1414b outside bent portion,
1415a,1415b inside bent portion,
17, 63a, 63b, 63c, 217, 417, 517, 617, 717, 817, 917, 1017, 1117, 1217, 1217X, 1217Y, 1217Z, 1317, 1317X, 1317Y, 1317Z, 1417, 1417X, 1417Y, 1417Z, 2017, 2017X, 2017Y, 2017 Z coil

1. A stator of a rotary electrical machine comprising:
a core back that is formed in an annular shape;
a plurality of teeth that are provided in a circumferential direction of the core back;
a plurality of slots that are provided between the teeth; and
a coil including a plurality of conductor wires which are arranged in m stages (m is an integer of 2 or larger) in a radial direction of the core back inside the slots and arranged in n stages (n is an integer of 1 or larger and not larger than ½ of m) in the radial direction of the core back outside the slots;
characterized in that:
between the inside of the slot and the outside of the slot, the plurality of conductor wires configuring the coil are bent at an angle smaller than 180□ in the circumferential direction of the core back, and
between the bent part and the inside of the slot, the plurality of conductor wires configuring the coil are bent in the circumferential direction of the core back and in an opposite direction to a bending direction of the bent part.

2. The stator of the rotary electrical machine according to claim 1, characterized in that:
the coil has a polygonal shape.

3. The stator of the rotary electrical machine according to claim 2, characterized in that:
the coil has a decagonal shape.

4. The stator of the rotary electrical machine according to claim 2, characterized in that:
the coil has a tetradecagonal shape.

5. A rotary electrical machine using the stator according to claim 1.
